(19) United States
(12) Patent Application Publication
(10) Pub. No.: US 2020/0223692 A1
(43) Pub. Date: Jul. 16, 2020

(54) MICROWAVE-ASSISTED CATALYTIC REACTIONS USING MODIFIED BED PARTICLES

(71) Applicant: Polyvalor, Limited Partnership, Montreal (CA)

(72) Inventors: Sepehr Hamzehlouia, Montreal (CA); Jamal Chaouki, Dorval (CA)

(21) Appl. No.: 16/641,938

(22) PCT Filed: Jul. 30, 2018
(86) PCT No.: PCT/CA2018/051048

§ 371 Date: Feb. 25, 2020

Related U.S. Application Data
(60) Provisional application No. 62/552,074, filed on Aug. 30, 2017.

(51) Int. Cl. C01B 3/44; B01J 8/18; B01J 8/42; B01J 21/18; B01J 21/08; B01J 23/755; B01J 35/00; B01J 35/02

(52) U.S. Cl. CPC C01B 3/44; C01B 2203/0855; B01J 8/42; B01J 8/1836; B01J 21/18; B01J 21/08; B01J 23/755; B01J 35/0033; B01J 35/026; B01J 2208/00442; C01B 2203/0238; C01B 2203/1241; C01B 2203/1082; C01B 2203/1058; B01J 8/1827

(57) ABSTRACT

A modified bed particles, related methods and applications in processes involving microwave-assisted catalytic reactions. The bed particles modified to be used as a microwave receptor that is capable to simultaneously sustain heat generation mechanisms under microwave irradiations and physically act as catalyst support. The bed particle comprises a dielectric coating deposited on an external surface of a core, the bed particle being sized for use in a fixed bed reactor or a fluidized bed reactor. The bed particles may further comprise a catalytically active material supported on a surface of the dielectric coating. Irradiating the gas-solid reactor with microwaves enables heating the dielectric coating of the solid bed particles, the dielectric coating locally transferring thermal energy to the surrounding gaseous reactants which are thereby selectively converted into the primary products.

### TECHNICAL FIELD

The technical field generally relates to microwave-assisted catalytic reactions and more particularly to modified bed particles having catalytic and dielectric properties and their uses.

### BACKGROUND

Catalytic reactions refer to chemical processes involving catalysts to promote the reaction rate by decreasing the activation energy of the reactants. By providing an alternative reaction route having a lower energy barrier, catalytic reactions enable higher selectivity and yield of desired products. Homogeneous catalysis refers to a catalysis wherein catalyst and reactants are in a same and homogeneous phase (liquid, solid or gas), whereas heterogeneous catalysis refers to a catalysis wherein catalyst and reactants are not in a same phase (solid and gas for example).

In some cases, catalysts may simultaneously facilitate formation of undesired by-products from the just formed desired products. For example, catalysts used to promote dry reforming of hydrocarbons in order to produce syngas, also promote undesired gas-phase reactions, thereby reducing the yield of syngas production by converting CO and H₂ into H₂O, CO₂, long chained aromatic and aliphatic hydrocarbons, and solid carbon by-products.

Known ways to reduce or prevent undesired by-products interference include microwave heating enabling a reaction selectivity tailored to form the desired products. In heterogeneous catalysis, as gaseous reactants typically do not have sufficient dielectric properties to have microwave absorption and intractability, microwave receptors are used to absorb and transmit heat inside the reactional system. It should be noted that a microwave receptor refers to herein as a dielectric material having high microwave absorption and intractability.

Quality of microwave interaction with the catalyst is directly related to the type of material used as active phase or support for the catalyst. In the case where the active phase or support material has adequate dielectric properties, it can act as the microwave receptor to produce the required reaction heat. The reaction can therefore proceed without addition of supplementary microwave receptor. Otherwise, microwave receptors can be added within the reactional system to overcome the microwave absorption and intractability deficiency and provide for adequate thermal requirements of the process. For example, Menendez, et al. (Microwave heating processes involving carbon materials. Fuel Processing Technology. 1// 2010;91(1):1-8), Russell et al. (Microwave-assisted pyrolysis of HDPE using an activated carbon bed. RSC Advances. 2012;2(17):6756-6760) and Tai et al. (Application of granular activated carbon packed-bed reactor in microwave radiation field to treat phenol. Chemosphere. 5// 1999;38(11):2667-2680), provide examples of use of microwave heating to obtain an optimized control of the reaction temperature profile.

Problems associated with microwave heating for heterogeneous catalytic reactions include, in the case of applications in fluidized bed with additional microwave receptors, disruption of the magnetic field and uniform temperature distribution due to segregation phenomena. As shown by Gómez-Barea et al. (Estimation of gas composition and char conversion in a fluidized bed biomass gasifier. Fuel. 2013;107(0):419-431), this segregation is based on the density and size gradient of bed particles and microwave receptors. Segregation causes the formation of hot spots, eliminating the uniform temperature distribution within the fluidized bed reactor. Furthermore, in case of fixed bed applications, the non-uniform distribution of receptors in the bed material can also lead to the formation of local hot spots and large temperature gradient.

There is thus a need for improved microwave heating techniques in heterogeneous catalysis reducing or preventing the above-mentioned problems.

### SUMMARY

Techniques described herein relates to microwave-assisted catalytic reactions through heating of a bed material having dielectric and catalytic properties. The bed material is used to selectively catalyze gas phase reactions, as solid bed particles of a gas-solid reactor. By using a bed material having both catalytic and dielectric properties, microwave heating provide control leverage on a temperature gradient between the catalytic solid phase and the reactive gas phase, which allows enhanced selectivity for targeted products.

There are provided herein methods to convert a typical bed material of a fixed bed or fluidized bed reactor into a microwave receptor that is capable to simultaneously sustain heat generation mechanisms under microwave irradiations and physically act as catalyst support.

In one aspect, there is provided a method for selectivity converting gaseous reactants into primary products over undesired secondary products. The method comprises providing a plurality of solid bed particles in a gas-solid reactor in presence of the gaseous reactants, each solid bed particle comprising a core and a dielectric coating deposited on a surface of the core. The method further comprises irradiating the gas-solid reactor with microwaves for heating the dielectric coating of the solid bed particles, the dielectric coating locally transferring thermal energy to the surrounding gaseous reactants which are thereby converted into the primary products.

Optionally, the method may include producing carbon-coated sand particles by thermal decomposition of methane to obtain a given amount of carbon, and chemical vapor deposition of the given amount of carbon as a carbon coating on the core. The thermal decomposition of methane and the chemical vapor deposition of the carbon coating may be performed simultaneously in an induction-heated fluidized bed reactor. The method may include controlling a reaction time and temperature within the induction-heated fluidized bed reactor to obtain a uniform carbon coating of a desired thickness over the core.

In some implementations, the method may include supporting a catalytic material on the surface of the dielectric coating of the bed particle. Supporting the catalytic material may be performed via impregnation, plasma deposition, polyol-assisted deposition, hydrothermal synthesis or ultrasound-assisted deposition.

In another aspect, there is provided a bed particle comprising a core particle and a dielectric coating deposited on an external surface of the core particle, the bed particle being sized for use in a fixed bed reactor or a fluidized bed reactor. The core particle may be made of a bed material suitable for a gas-solid reactor.

In some implementations, the bed particles may further comprise a catalytically active material supported on a surface of the dielectric coating, the catalytically active material being heated via thermal conduction from the heated dielectric coating and further increasing conversion of the surrounding gaseous reactants into the primary products.

In some implementations, the core is made of silica, alumina, olivine, FCC, zeolite, quartz, glass a combination thereof.

In some implementations, the dielectric coating is made of a material having a ratio of loss factor to a dielectric constant between 0.5 to 1. The dielectric coating may be made of a metallic compound, a carbonaceous compound, or a combination thereof. The metallic compound may be a transition metal or a noble metal. More particularly, the metallic compound may be titanium, vanadium, chromium, manganese, iron, cobalt, nickel, copper, zinc or an alloy thereof. The carbonaceous compound can be in the form of graphine, graphite or amorphous carbon.

In some implementations, the bed particles may have a particle size distribution ranging from 70 microns to 1 mm.

In some implementations, the bed particles are carbon-coated sand particles, for which the core of each solid bed particle is made of silica sand and the dielectric coating is made of carbon. The solid bed particle may have a carbon content between 0.1 wt % and 3 wt % with respect to a total weight of the particle. The carbon-coated sand particles may have a particle size between 200 and 250 μm. The dielectric carbon coating comprises a plurality of carbon nanosized layers deposited on the core.

In another aspect, there is provided a use of the bed particles as defined herein, as a catalyst support for supporting a catalytically active material.

In another aspect, there is provided a use of the bed particles as defined herein, as a microwave receptor in a microwave-assisted thermochemical process.

In another aspect, there is provided a use of the bed particles as defined herein, for enhancing selectivity and yield of partial oxidation of hydrocarbons such as n-butane, pyrolysis, biomass gasification, thermal cracking, gas cleaning and any thermochemical conversion.

In another aspect, there is provided a process for reforming methane into syngas, the process comprising exposition of methane to a microwave heated bed within a fluidized bed containing bed particles, each bed particle comprising a core, a dielectric coating deposited on an external surface of the core, and a catalytically active phase supported on the dielectric coating.

In some implementations, the catalytically active phase may be selected to catalyze the following primary gas-phase reaction: CH₄+CO₂→2CO+2H₂

In some implementations, the catalytically active phase is a transition metal. Optionally, the transition metal may be titanium, vanadium, chromium, manganese, iron, cobalt, nickel, copper, zinc or an alloy thereof. Further optionally, the catalytically active phase is nickel.

In some implementations, the core may be made of silica, alumina, olivine, FCC, zeolite, quartz, glass a combination thereof. Optionally, the core may be made of silica sand.

In some implementations, the dielectric coating may be made of a metallic compound, a carbonaceous compound, or a combination thereof. Optionally, the dielectric coating may be made of carbon. Further optionally, the dielectric coating may include a plurality of nanosized carbon layers.

In some implementations, the reforming may be performed at a temperature range between 650° C. and 900° C.

In another aspect, there is provided a process for thermally cracking a hydrocarbon-containing stream, the process comprising:
irradiating catalytic and dielectric bed particles provided within a fluidized bed reactor with microwaves, the catalytic and dielectric bed particles comprising a core particle, a dielectric coating provided on an external surface of the core particle, and a catalytically active phase supported on the dielectric coating and having active sites; and
contacting the hydrocarbon-containing stream with the heated catalytic and dielectric particles to locally transfer heat from the catalytic and dielectric bed particles to the hydrocarbon-containing stream, and thereby selectively activate cracking reactions into primary products.

It should be noted that the above-mentioned techniques, methods and processes may be applied to assist any reactions in partial oxidation of hydrocarbons, pyrolysis, biomass conversion, thermal cracking, gas cleaning and any thermochemical conversion.

### BRIEF DESCRIPTION OF THE DRAWINGS

Embodiments of the modified bed material and related methods or uses are represented in and will be further understood in connection with the following figures.

FIG. 1 is schematic process flow diagram of the steps of a method to activate primary gas-phase reactions by microwaves irradiation in a fluidized bed reactor.

FIG. 2 is a schematic zoomed representation of catalytically and dielectrically modified bed particles under microwave heating to locally convert gaseous reactants with a high selectivity towards primary gas products which remain cold.

FIG. 3 is a schematic illustration of an equipment setup for a induction-assisted fluidized bed chemical vapor deposition (FBCVD) process to produce dielectric bed particles.

FIG. 4 is a graph showing the temperature profile of the fluidized bed of FIG. 3 during heating and reactions stages.

FIGS. 5a and 5b are graphs showing representative TGA results for dielectric bed particles produced under different FBCVD temperatures and reaction times: a) 120 min and b) 240 min under air.

FIGS. 6a and 6b are graphs showing representative TGA results for dielectric bed particles produced under different FBCVD temperatures a) 900° C. and b) 1000° C. for three different durations.

FIG. 7 includes six SEM observations of bed particles a) pure sand particles b) carbon-coated sand particles at 800 C and 60 minutes; c) carbon-coated sand particles at 800 C and 120 minutes; d) carbon-coated sand particles at 900 C and 60 minutes; e) carbon-coated sand particles at 900 C and 240 minutes; and f) carbon-coated sand particles at 1200 C and 240 minutes (FBCVD temperatures and reaction times).

FIG. 8 includes three SEM observations of the evolution of the coating layer thickness using FIB milling of a) 800 C, b) 900 C, c) 1000 C for 240 min (FBCVD temperatures and reaction time).

FIG. 9 includes four EDX results of a) uncoated sand particles b) carbon-coated sand particles at 800 C and 240 minutes; c) carbon-coated sand particles at 900 C and 240 minutes; d) carbon-coated sand particles at 1000 C and 120 minutes (FBCVD temperatures and reaction times).

FIG. 10 is a schematic illustration of an equipment setup for a microwave-assisted heating of dielectric bed particles.

FIG. 11 is a graph showing microwave heating performance of dielectric bed particles (C—SiO₂) produced at multiple FBCVD temperatures and (a) 60 min, (b) 120 min and (c) 240 min reaction time at 0.2 Amps power cycle.

FIG. 12 is a graph showing microwave heating performance of dielectric bed particles (C—SiO₂) produced at (a) 800° C., (b) 900 ° C. and (c) 1000° C. FBCVD temperatures and multiple reaction durations at 0.2 Amps power cycle.

FIG. 13 is a graph showing the effect of microwave power on heating performance of dielectric bed particles (C—SiO₂) produced at (a) 800° C., (b) 900° C. and (c) 1000° C. FBCVD temperatures and 240-min time at different microwave power cycles.

FIG. 14 is a graph showing durability and attrition test results for dielectric bed particles (C—SiO₂) obtained at (a) 800° C. and 120 mins, (b) 900° C. and 240 mins and (c) 1000° C. and 60 mins FBCVD operational conditions at 0.2 Amps microwave power cycle.

FIG. 15 is a graph showing microwave heating performance of (a) 1% (b) 5%, (c) 50% and (d) 90% graphite to sand mixtures at different microwave powers.

FIG. 16 is a graph showing comparative microwave heating performance of different graphite and sand mixtures at 0.2-Amp microwave power.

FIG. 17 is a graph showing comparative microwave heating performance of 50% and 90% graphite to sand mixtures and coated particles at 800, 900, 1000° C. and 240 mins FBCVD operational conditions.

FIG. 18 is a graph showing the heating rate efficiency of the microwave receptor material as a function of carbon content for three microwave power (0.1, 0.2 and 0.3 Amps)

FIG. 19 is a schematic diagram of an apparatus assembly enabling microwave heating temperature distribution investigation.

FIG. 20 is a graph of temperature (in ° C.) of the bulk phase and the solid phase versus the distance (in cm) from the quartz distributor (seen on FIG. 3) in a C—SiO₂ receptor bed, the solid phase temperature distribution corresponding to the thermopile temperature.

FIG. 21 is a graph of a graph of temperature (in ° C.) of the solid phase (700° C.) and the bulk phase versus the distance (in cm) from the quartz distributor in the C—SiO₂ receptor bed for three gas superficial velocities.

FIG. 22 is a graph of a graph of temperature (in ° C.) of the gas, solid and bulk phases versus the distance (in cm) from the quartz distributor in the C—SiO₂ receptor bed for a gas superficial velocitity u_{g}=3.4 cm.s⁻¹.

FIG. 23 is a graph of a graph of temperature (in ° C.) of the gas, solid and bulk phases versus the distance (in cm) from the quartz distributor in the C—SiO₂ receptor bed for a gas superficial velocitity u_{g}=6.6 cm.s⁻¹.

FIG. 24 is a graph of a graph of temperature (in ° C.) of the gas, solid and bulk phases versus the distance (in cm) from the quartz distributor in the C—SiO₂ receptor bed for a gas superficial velocitity u_{g}=10 cm.s⁻¹.

FIG. 25 is Scanning Electron Microscope (SEM) image of graphite-coated silica sand (C—SiO₂) particles.

FIG. 26 is a schematic illustration of an equipment set-up used to deposit nickel on graphite-coated silica sand particles.

FIGS. 27 to 30 are SEM images of a nickel deposit on graphite-coated silica sand (C—SiO₂) particles using ultrasound-assisted incipient wetting impregnation in water as transmission medium.

FIGS. 31 to 33 are SEM images of a nickel deposit on graphite-coated silica sand (C—SiO₂) particles using ultrasound-assisted incipient wetting impregnation in oleic acid as transmission medium.

FIG. 34 is a graph of conversion of the reactants (CH₄ and CO₂) versus the reaction time in s.

FIG. 35 is a graph of conversion of the reactants (CH₄ and CO₂) versus temperature in ° C.

FIG. 36 is a graph of selectivity for the syngas products (H₂ and CO) versus the reaction time in s.

FIG. 37 is a graph of selectivity for the syngas products (H₂ and CO) versus temperature in ° C.

FIG. 38 is graph of CO selectivity versus CO₂ conversion during microwave heated dry reforming of methane using modified bed material.

FIG. 39 is graph of H₂ selectivity versus CH₄ conversion during microwave heated dry reforming of methane using modified bed material.

FIG. 40 is a graph of the dielectric constant of a graphite-coated silica sand particle versus temperature.

FIG. 41 is a graph of the loss factor of a graphite-coated silica sand particle versus temperature.

While the invention will be described in conjunction with example implementations, it will be understood that it is not intended to limit the scope of the techniques to such implementations. The objects, advantages and other features of the present invention will become more apparent and be better understood upon reading of the following non-restrictive description, given with reference to the accompanying drawings.

### DETAILED DESCRIPTION

It should be noted that the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only. Therefore, the descriptions, examples, methods and materials presented in the claims and the specification are not to be construed as limiting but rather as illustrative only.

It is worth mentioning that throughout the following description when the article “a” is used to introduce an element it does not have the meaning of “only one” it rather means of “one or more”. It is also to be understood that where the specification states that a component, feature, structure, or characteristic “may”, “might”, “can” or “could” be included, that particular component, feature, structure, or characteristic is not required to be included.

In the above description, an embodiment is an example or implementation of the inventions. The various appearances of “one embodiment,” “an embodiment” or “some embodiments” and “some implementations” do not necessarily all refer to the same embodiment. Although various features of the invention may be described in the context of a single embodiment, the features may also be provided separately or in any suitable combination. Conversely, although the invention may be described herein in the context of separate embodiments for clarity, the invention may also be implemented in a single embodiment.

Microwave heating provides for a unique temperature distribution scheme generated inside the reactor. While in conventional heating methods, the heat is provided by an external source, microwave heating mechanism is governed by the interaction of an electromagnetic wave with the dielectric material placed within the reaction zone of the gas-solid reactor. Consequently, the temperature across the dielectric material is significantly higher than a bulk temperature.

Moreover, due to the insignificant dielectric properties of gases in general, there will be no interaction between the gas phase components and the microwave. This mechanism provides an opportunity for catalytic reactions. Whereas, higher local temperature on the active sites promotes higher selectivity and yield of the catalytic reactions, while lower bulk temperature and negligible microwave interaction of the gaseous components restricts the prospect of the undesired gas phased reactions.

Present techniques provide for microwave heating of a catalytic and dielectric material used to selectively catalyze primary gas phase reactions, the catalytic and dielectric material being used as solid bed particles of a gas-solid reactor. By using a bed material having both catalytic and dielectric properties, microwave heating provide control leverage on a temperature gradient between the catalytic solid phase and the reactive gas phase, which allows enhanced selectivity for primary products while reducing or preventing formation of secondary by-products.

It should be noted that the time during which the modified bed material is irradiated can be tailored to activate primary gas-phase reactions and/or secondary gas-phase reactions. Advantageously, in a process wherein products from secondary gas-phase reactions are considered undesirable, irradiation can be tailored to only activate primary gas-phase reactions.

Dielectric properties of a material are known to be governed by temperature, moisture content, and density of a material. These dielectric properties are directly related to microwave absorption and intractability capacity. A microwave receptor will be considered herein as including a material with high microwave absorption and intractability. A suitable candidate as a microwave receptor is a material for which the ratio of loss factor to the dielectric constant is between 0.5 to 1.

Materials used as bed particles, catalytic active phase or catalytic support may not have adequate dielectric properties to qualify as a microwave receptor. Use of additional microwave receptors provided within the bed particles of a fixed bed or fluidized bed reactor to absorb and transfer heat within the reactional system is associated to, as mentioned in the background section, non-uniform temperature distribution and segregation issues. To overcome or at least reduce these issues, there are provided bed particles modified with a dielectric material and configured to be used as a microwave receptor, a catalyst support and even catalytic particles within a gas-solid reactor. It should be noted that if the dielectric material of the dielectric particles already possesses catalytic properties, the dielectric particles can be used as is to locally heat a gas phase and selectively activate reactions towards primary products. However, in the case the dielectric material is not suited as a catalyst, the dielectric layer of the dielectric particle can be used as a support surface for a supported catalyst. Alternatively, catalyst particles may be mixed with the dielectric particles within the reactor. Preferably, in that latter case, the catalyst particles and the dielectric bed particles are in the same size range.

Therefore, a person skilled in the art will easily understand that a catalytic and dielectric particle refers herein to a bed particle being paired with a dielectric and catalytic material, or to a bed particle being paired with a layer of dielectric material onto which a catalytic active phase is supported.

### Dielectric Bed Particles Implementations

Present techniques include modification of bed particles of a gas-solid reactor with a dielectric material to produce dielectric bed particles able to absorb and transfer heat to gaseous reactants within the reactor. Pairing of bed particles material with a dielectric material to act as microwave receptors is further described herein.

In some implementations, there is provided a dielectric bed particle including a core particle, and a dielectric coating provided on an external surface of the core particle.

The core particle can be made of any material suited for use as a bed material of a gas-solid reactor. The core may be made of a metal oxide, a carbonaceous material, silica sand, a ceramic material, a polymer, a composite material or a combination thereof. For example, different sand grades can be used as bed material to form the core particle, thereby referred to as a sand particle. It should be noted that a sand particle may be herein referred to or equivalent to a silica particle or a silica sand particle. Alternative core particle material includes alumina, olivine, FCC, zeolite quartz, glass or a combination thereof. The dielectric coating may be made of metallic compounds including transition metals and noble metals, or carbonaceous compounds in the form of graphine, graphite with or without amorphous state. Various forms of carbon can be used as microwave receptors for heating purposes.

The produced dielectric bed particles can be used as microwave receptor in fixed and fluidized bed reactors. In addition to minimizing segregation and temperature gradient problems, the use of dielectric bed particles as microwave receptor can promote lower energy consumption. Indeed, upon microwave heating thereof, only the dielectric coating will be heated while the core particle remains thermally unaffected, thus minimizing the energy required to sustain the reactants conversion.

It should be noted that the modified bed particles are suited to be used in any reactor including bed material, such as a fluidized bed reactor, circulating fluidized bed reactor, a packed-bed reactor. Geometry of the bed particles includes spherical, cylindrical or any other geometry suited for a bed particle, having a particle size distribution ranging from 70 microns to 1 mm.

In some implementations, there is provided a process for producing a carbon-coated sand particle usable as a dielectric bed particle for a fixed or fluidized bed reactor. The process includes thermal decomposition of methane, acting as a precursor, to obtain a desired carbon content. The process further includes chemical vapor deposition (CVD) of the carbon coating on the sand particles to form the carbon-coated sand particles. Both thermal decomposition of methane and chemical vapor deposition of the coating can be performed in an induction heating fluidized bed reactor (IHFBR) exhibiting high heating rate and mixing to enable a uniform and durable coating outcome including 90% of graphene. Combined thermal decomposition and deposition of carbon may be referred to as an induction-assisted fluidized bed chemical vapor deposition (FBCVD) technique. Experiments have shown that amount of dielectric material deposition on the bed particles is a function of reaction time and temperature (see Example 1). The process may therefore include controlling a reaction time and temperature of the induction-assisted FBCVD to obtain a uniform dielectric coating of a desired thickness over the bed particle. In some implementations, the dielectric bed particle may include a core of sand and an external layer of carbon, the dielectric bed particle having a carbon content between 0.1 wt % and 3 wt % with respect to a total weight of the particle (see Example 2).

Optionally, the particle size of the dielectric bed particles may be between 150 and 300 μm, such that they pertain to the Geldart group B and are suitable for application in fixed and fluidized beds. For example, the carbon-coated sand particles (C—SiO₂) may have a particle size between 200 and 250 μm.

In some implementations, the dielectric carbon-coated bed particle includes a core and a plurality of carbon nano-layers deposited on the core, the nano-layers boosting the conductivity of the particle, thereby leading to a superior microwave heating performance when the particle is used as a microwave receptor. It has been found that carbon nano-layers deposited on the core (bed particle) facilitate the travel of electrons through vacant orbitals of carbon, thereby increasing microwave heating performance of the dielectric carbon-coated bed particle.

It should be however noted that the present dielectric bed particles should not be limited to carbon-coated sand particles and that one skilled in the art can understand how to coat a dielectric material on a core particle, depending on the techniques available in the art for each type of selected materials. Materials for the core particle and the dielectric coating may be selected according to reaction conditions. For example, the dielectric material forming the coating may be selected to resist potential oxidation and hydrogenation conditions within the reactor.

### Catalytic and Dielectric Bed Material Implementations

Catalysts include metallic and non-metallic catalysts. They are typically deposited on a support material in order to keep the catalytic active phase in a discrete state, and therefore referred to as supported catalysts. Selection of the support material is associated with certain characteristics namely, physical and chemical stability, inertness, mechanical properties, surface area and porosity. According to these characteristics, three types of material typically display adequate properties for industrial catalytic applications: alumina, silica and carbon. Supported catalysts facilitate gas circulation and diffusion of reactants over active sites of the catalyst, thereby optimizing reaction heat distribution and preventing sintering of these active sites.

In some implementations, there is provided a catalytic and dielectric bed particle including a core particle, a dielectric coating provided on an external surface of the core particle, and optionally a catalytically active phase supported on the dielectric coating and having active sites.

Present techniques also include use of the formed dielectric bed particles as a support for the catalytic material or active phase. The modified dielectric bed particles are capable of simultaneously sustaining a heat generation mechanism through microwave irradiation and acting as catalyst support. Present techniques further include formation of catalytic and dielectric bed particles by supporting the catalytic material on the modified dielectric bed particles.

It should be noted that catalyst deposition on the modified dielectric bed particle includes techniques available to one skilled in the art to combine an active phase of the catalyst with a support surface. Deposition for example includes impregnation, plasma deposition, polyol-assisted deposition, and hydrothermal synthesis. When porosity of the dielectric coating does not provide an adequate surface area, catalyst active phase deposition may include sonochemistry, i.e. use of ultrasounds, to create additional specific surface area to the particle for the catalyst to be supported thereon (see experimentation section).

For example, ultrasound-assisted deposition of a catalytically active specie on the dielectric bed particle may include subjecting dielectric bed particles to ultrasonic waves in presence of the catalytically active specie in a liquid medium. The shocks created by the ultrasonic waves create additional pores at the surface of the dielectric bed particles and force impregnation of the catalytically active specie within the pores of the dielectric bed particles. Subjecting the solid support to ultrasonic waves may comprise generating the ultrasonic waves proximate to the surface of the dielectric bed particles. Agitation of the liquid medium may be performed by stirring mechanically or by bubbling a gas. The catalytically active specie may be present with a weight percentage from 0.5 to 20% of the weight of the support. For example, a metal-containing active specie may be coated by ultrasound-assisted deposition on the dielectric carbon-coated sand particles defined herein. Additional details are available in the PCT application claiming priority of the US provisional application No. 62/552.063.

### Microwave Heating Process Implementations

Microwave heating is the result of increased kinetic energy triggered by reorientation of molecular dipoles exposed to an oscillating electric field. In microwave heating, complex permittivity (ε*) is the decisive parameter in evaluating the heat generation within an exposed dielectric material according to the following equation (1):

ε*=ε′−jε″ (1)

where the real part of equation (1) is known as dielectric constant (ε′), representing the potential of the exposed material to conserve electric energy. The imaginary part of equation (1) is called the loss factor (ε″), which demonstrates the ability of the exposed material to dissipate microwave energy. The ratio of the loss factor to the dielectric constant, referred to as the loss tangent, denotes the amount of dissipated microwave energy converted to thermal energy within a dielectric material. Mathematical definition of the loss tangent is expressed according to equation (2):

$$t a n δ = \frac{{ɛ}^{″}}{{ɛ}^{′}} \qquad ( 2 )$$

Although the loss tangent is the major contributor to the dielectric microwave-heating rate, other parameters including the electric field pattern, heat capacity, and density of the compound affect the heat generation regime significantly.

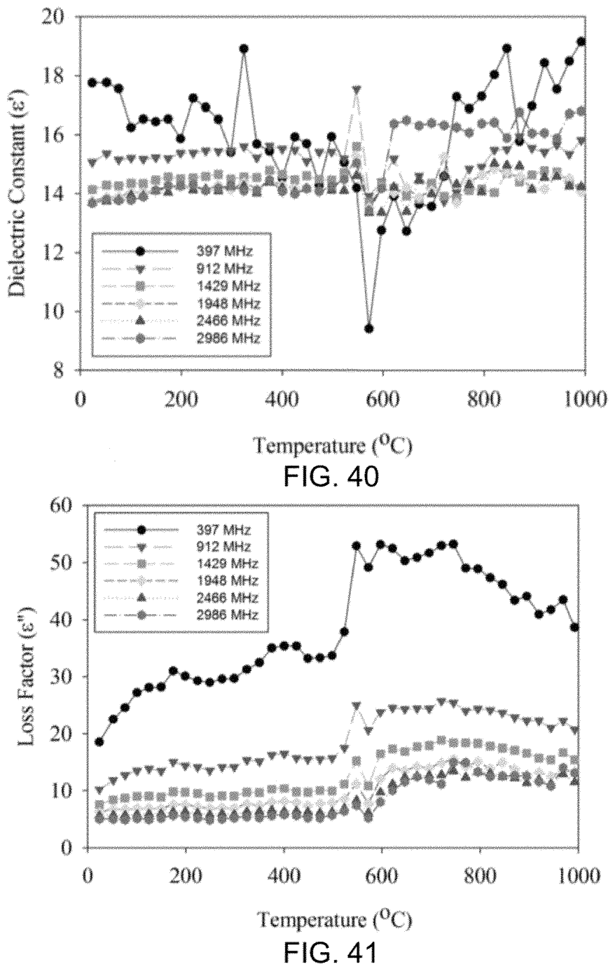

FIGS. 40 and 41 illustrate respectively the dielectric constant and the loss factor of a graphite-coated silica sand particle according to temperature.

Due to their chemical and physical structure, most common compounds such as gases (O₂, N₂ and CO₂), wood residues (lignin, paper and cellulose), plastics (polystyrene, nylon and rubber) and ceramics (quartz, alumina and Pyrex) are transparent or project low intractability with microwave radiation. Conversely, the microwave receptors defined herein are considered as material with high microwave absorption and intractability. They can therefore be utilized to absorb microwaves and transform it into thermal energy while exposed to microwave radiation.

Present techniques include a microwave-assisted heating process for enhanced performance of gas-solid reactions. The process includes microwave heating of the bed particles, the bed particles being modified at least to include a dielectric coating acting as microwave receptor, to absorb and transfer heat to the gaseous reactants, which can thereby be locally converted into primary products. As the dielectric coating of the bed particles is heated by microwave, a temperature gradient is created between the dielectric coating and the gas phase. This tailored temperature gradient enables for selectively converting reactants into primary products in a fixed bed reactor or a fluidized bed reactor, while minimizing further reactions towards undesired secondary products in gas phase.

It should be noted that modifications of the bed particles to provide bed material with at least dielectric properties (optionally dielectric and catalytic properties) may be tailored to the needs of the targeted chemical reactions.

For example, modification of the bed particles may be performed to provide a dielectric coating thereon and form dielectric bed particles. As mentioned-above, if the dielectric material has also catalytic properties towards the targeted reactions, the particles produced are dielectric and catalytic bed particles. In this implementation, the microwave heating process includes irradiating the dielectric bed particles to provide heat to the gas-solid reactional system. This implementation may be suited for gaseous chemical reactions which are endothermic but do not necessarily need a catalyst.

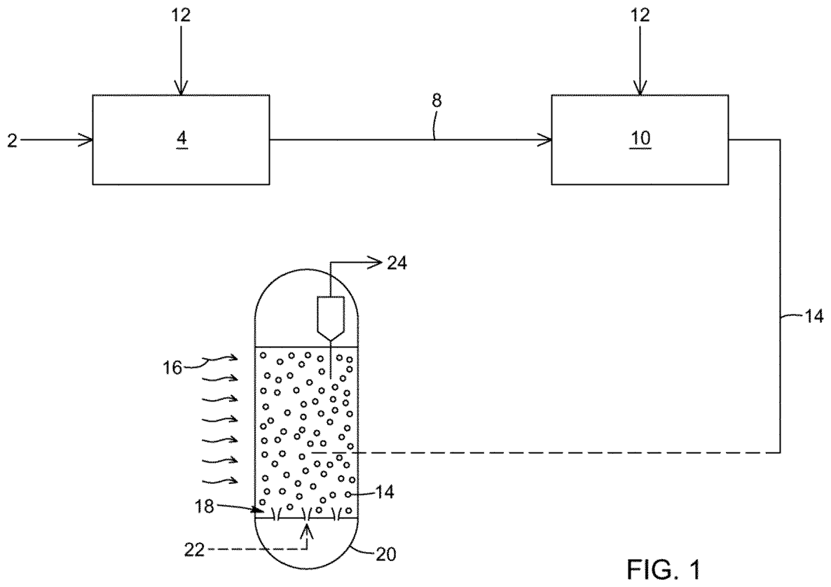

In another example, referring to FIG. 1, modification of the bed particles (2) may include a first deposition (4) of a dielectric material (6) on the surface of the bed particles (2) to produce dielectric particles (8), and a second deposition (10) of a catalytic material (12) over the surface of the dielectric particles 8), thereby forming catalytic and dielectric bed particles 14). In this implementation illustrated in FIG. 1, the microwave heating process includes subjecting the catalytic and dielectric bed particles (14) to microwave (16) in order to locally provide heat to the gas-solid reactional system (18), around the active sites of the catalytic and dielectric bed particles (14). A fluidized bed reactor (20) is used to fluidize the catalytic and dielectric bed particles (14) with a reactional gas (22) which is converted into primary reaction products (24) when contacting the heated catalytic and dielectric bed particles (14).

Microwave heating of the catalytic and dielectric bed particles within a fixed bed or fluidized bed reactor enables a uniform thermal energy production from the dielectric coating of each bed particle while reducing or preventing segregation phenomena causing hot spots in the reactor. Pairing of the bed material and a dielectric material provide for a uniform and unique temperature gradient profile. The application of an external heating source, such as partial combustion of a hydrocarbon, is therefore not required, thus avoiding generating the emission of undesirable gases.

Additionally, the local temperature and heating rate around the heated catalytic and dielectric bed particles are considerably higher than the relative bulk properties (contribution of gas and solid properties), thus providing an exclusive opportunity for selectively enhance catalytic reactions. The microwave heating regime can enable higher selective reaction rate on the active sites of the catalytic and dielectric bed particles, while reducing the energy consumption of the whole process. Consequently, as the catalytic and dielectric bed particles are used as microwave receptor and catalyst, they promote gas-solid catalytic reactions while restricting the undesired gas phase side reactions due to the limited temperature gradient produced within the reactor.

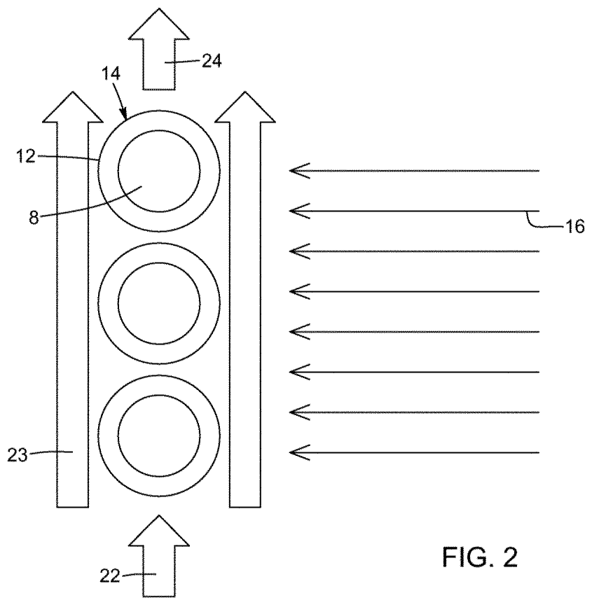

Indeed, as seen on FIG. 2, the primary gaseous products (24) are not heated by the microwave heating (16), thereby having an activation energy insufficient to transition into undesired secondary products.

It should be noted that microwave heating of the present dielectric and catalytic bed particles can be used to enhance catalytic reactions including partial oxidation of hydrocarbons such as n-butane, pyrolysis, biomass conversion, thermal cracking, gas cleaning and any thermochemical conversion. Various petrochemical processes to generate basic feedstock or higher-value petrochemicals could benefit from the presently taught techniques to simultaneously optimize selectivity and conversion of the reactions, while reducing the size of the reactors compared to conventional heating methods.

### Microwave-Assisted Dry Reforming of Methane (DRM)

In some implementations, there is provided a process for converting methane into syngas including exposition of methane to a microwave heated bed within a fluidized bed, the bed including the dielectric and catalytic bed particles defined herein.

Dry reforming of methane is an endothermic catalytic reaction with multiple prospective reaction pathways as seen in Table 5 below. Reaction (1) is the anticipated root to produce syngas, while reactions (2) to (17) deteriorate the quality of the final product by evolution of the secondary by-products or deactivation of the catalyst active sites through carbon deposition:

CH₄+CO₂→2CO+2H₂ ΔH₂₉₈⁰=+247 kJ mol⁻¹ (1)

The resilient C—H bond necessitates the application of an appropriate catalyst to initiate the reaction. Although signified as a renowned process to produce syngas, the complex reaction pathway deteriorates the quality of the final product due to secondary gas-phase reactions. Furthermore, the production of carbon residues accelerates the deactivation of the catalyst active sites, whereas thermal degradation of methane,

CH₄→C+2H₂ ΔH₂₉₈⁰=74.9 kJ mol⁻¹

water gas shift reaction,

CO+H₂O↔CO₂+H₂ ΔH₂₉₈⁰=−41.2 kJ mol ^{31 1}

and carbon monoxide disproportionation (Boudouard reaction)

2CO→C+CO₂ ΔH₂₉₈⁰=−172.4 kJ mol⁻¹

have been profoundly restricting the DRM reaction productivity. The application of transition metal catalysts, namely, nickel, has been studied herein for the DRM process due to the high reactivity with methane and the potential lower economic costs.

TABLE 5

| Reaction # | Reaction | AH₂₉₈(kJ/mol) |
|---|---|---|
| 1 | CH₄ + CO − CO + 2H₂ | 247 |
| 2 | CO₂ + H₂ − CO + H₂O | 41 |
| 3 | 2CH₄ + CO₂ − C2H6 + CO + H₂O | 106 |
| 4 | 2CH₄ + 2CO₂ − C2H4 + 2CO + 2H₂O | 284 |
| 5 | C₂H₆ − CH₄ + H₂ | 136 |
| 6 | CO + 2H₂ − CH₃OH | −90.6 |
| 7 | CO₂ + 3H₃ − CH₃OH + H₂O | −49.1 |
| 8 | CH₄ − C + 2H₂ | 74.9 |
| 9 | 2CO − C + CO₂ | −172.4 |

Performing DRM according to the present microwave heating techniques in a fluidized bed containing modified bed particles having catalytic and dielectric properties has shown to provide enhanced selectivity and conversion towards the primary products of reaction 1) while reducing the kinetics of the secondary gas phase reactions (see Example 5).

### Experimentation

### EXAMPLE 1

### Production of Graphite-Coated Silica Sand Particles with Enhanced Specific Surface Area

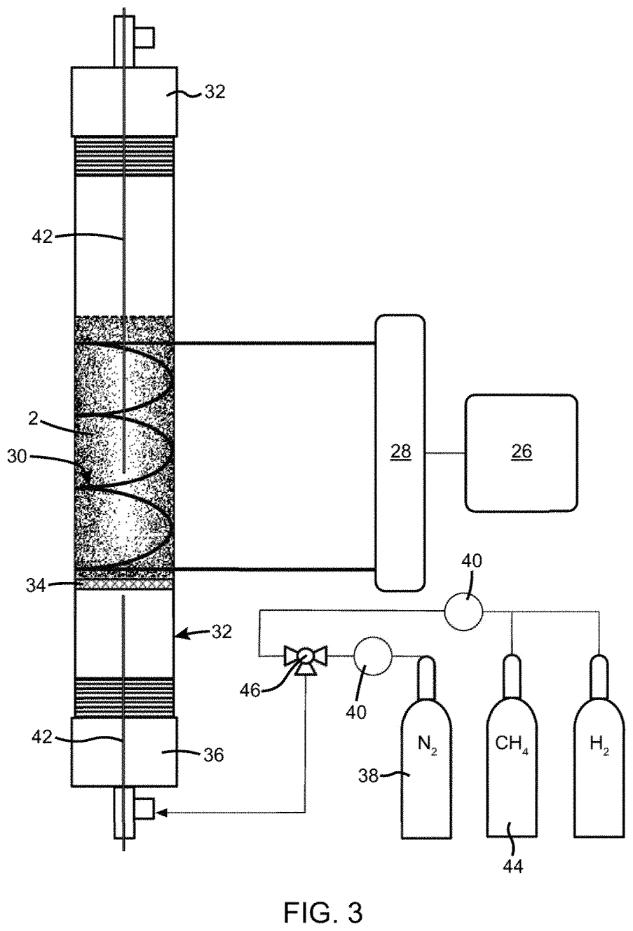

An induction heating-assisted fluidized bed chemical vapor deposition (FBCVD) reactor was employed to thermally decompose methane and deposit the generated carbon on the surface of silica sand particles that were under bubbling fluidization conditions according to the experimental equipment set up schematized in FIG. 3.

Materials
Geldart's group B industrial silica sand (SiO₂) particles (ρₚ=2.6 g/cm³, dₚ=212-250 μm) were used as bed particles for the FBCVD process. Methane (99.92% purity, Canadian Air Liquid) and nitrogen (99.99% purity, Canadian Air Liquid) were used as the carbon precursor component and the fluidizing gas, respectively. Finally, micro-sized graphite powder (99.99% purity, <150 μm, Sigma-Aldrich) to compare the microwave heating performance with various coated particle grades at different graphite-sand compositions.Fluidized bed chemical vapor deposition set-up

Referring to FIG. 3, a 10 KW power source (26) with a PID controller by Norax Canada was employed to provide a high frequency and voltage electrical field for induction heating applications. Furthermore, a matching box (28) and a 5cm outside diameter (OD) and 7.6cm high copper induction coil (30) was designed and manufactured by Norax Canada to induce the electrical current into the workpiece. The induction coil (30) was coated with polymer material in order to prevent harmful electric shocks. Water was running through the induction coil to maintain the temperature at lower levels. Chemical vapor deposition of methane was performed in a 2.5 cm OD, 0.3 cm width and 30 cm long stainless steel grade 316 tubular reactor (32). A distributor plate (34) was designed and manufactured in order to disperse the flow uniformly, minimize the risk of flow channeling and support the bed particles (2) inside the reactor (32). Removable stainless steel caps (36) were deployed for loading, unloading and reactor maintenance on both sides of the tubular reactor (32).

Protocole

Still referring to FIG. 3, for each test, 60 g silica sand was added to the reactor (32). The particles (2) were initially fluidized with nitrogen flow (38) in a bubbling regime where U/Umf ratio was in the region of 2 to 4. The nitrogen flow was maintained using a mass flow controller (40) (Bronkhorst F-201CV), with initial gas velocity of 10 cm/s. In order to maintain the bubbling fluidization regime throughout the reaction at a fixed U/Umf, using LabView software and a type K thermocouple (42) monitoring the reaction zone temperature, the inlet gas velocity was reduced at elevated temperatures proportional to the initial gas velocity and the initial temperature. The induction power source (26) was programmed through the PID controller interface to approach and maintain a setpoint reaction temperature for the bed of sand particles (2). Once the bed temperature reached the setpoint value and stabilized, the flow of carbon precursor (44), methane, was turned on using an automatic solenoid valve (46). The methane superficial gas velocity was maintained constant at 2.3 cm/s during the reaction period using another mass flow controller 40) (Bronkhorst F-201CV). The bed (2) and distributor plate (34) temperatures and the gas flow (44) were constantly monitored with the LabView software. The FBCVD of carbon over silica sand particles was repeated at 800, 900 and 1000° C. temperatures for 60-, 120- and 240 -minute reaction times, where all the experiments were performed at atmospheric pressure.

In order to maintain similar fluidization regime at all temperatures, the gas flow was continuously re-adjusted according to the bed temperature based on the following equation (3):

$${U}_{adj} = {U}_{0} \times ( \frac{{T}_{0}}{{T}_{R}} ) \qquad ( 3 )$$

where U_{adj} is the adjusted gas velocity, Uo is the initial gas velocity value generally set at 10 cm/s, T₀ the initial reactor temperature, which was equivalent to the laboratory temperature and T_{R} is the reaction temperature in K constantly monitored by a type K thermocouple during the heating period and the reaction stage.

Following the completion of each reaction at the designated temperature and reaction time, the coated particles were unloaded through the removable reactor cap, stored in sealed glass vials and, subjected to a cooling stage under nitrogen purge. Subsequent to each test, the reactor and the distributor plate were cleaned to remove all residual carbon deposits using micro brush scrubbers and combustion under air.

The quantity of carbon deposited on the silica sand particles was assessed by means of thermogravimetric analysis (TGA) using a TA Instruments TGA Q-5000 apparatus in a temperature range of 25 to 1000° C. and ata heating rate of 10° C/min under air atmosphere with a flow rate of 20 mL/min and nitrogen as the purge gas at 20 mL/min. Furthermore, the TGA results investigated the thermal stability of the carbon-coated particles under air at high temperatures. The TGA study was further repeated under nitrogen to verify the effect of moisture and volatile matter presence in the samples.

The morphological characteristics and qualitative and quantitative properties of the carbon coating of the particles at different temperatures and reaction times were conducted by field emission scanning electron microscopy (SEM-FEG; model JSM-7600 TFE, JEOL, Japan) equipped with energy-dispersive X-ray spectroscopy (EDX; Oxford Instruments) and focused ionized beam (FIB; model 2000-A, Hitachi, Japan) microscopic analysis methods. The SEM was operated at 5 kV with LEI imaging mode and a working distance of 15 mm. The samples were vacuum coated for 15 seconds prior to the analysis by gold spattering device to restrict the charging effect of the particles.

Due to the size range of the particles, application of transmission electron microscopy (TEM) was impractical to investigate the status of the carbon coated layer. Hence, focused ionized beam (FIB) was used to investigate the carbon coating layer thickness and location on selected samples. These samples were vacuum coated with a tungsten layer prior to the milling step in order to minimize the destructive effect of the high-energy ionized beam on the coating surface. Following the selection of appropriate particles, a rectangular area of 30×10 μm² was milled on each sample particle to observe the carbon coating thickness and the layer location associated with each sample grade operated at 20 kV. Initial cuts were operated at high currents, and lower currents were employed to clean the site of interest. Ultimately, the milled samples were transferred to the SEM-FEG device, tilted for 30 degrees for proper visibility of the carbon layer, and microscopic images were captured at 3700 and 4300 magnifications. The quality of the coating was verified by EDX at different local spots of each sample. Furthermore, microscopic images of each sample at 50 and 100 magnifications were captured to investigate the effect of temperature and time on the morphology of the carbon-coating layer.

The surface characterization of the coated and the uncoated silica sand was performed by X-ray photoelectron spectroscopic (XPS) analysis carried out on a VG scientific ESCALAB 3 MK II X-ray photoelectron spectrometer using a MG Ka source (15 kV, 20 mA) to investigate the effect of temperature and time on the carbon layer formation. The survey scans were implemented at pass energy of 100 eV and energy step size of 1.0 eV at 10-nanometer penetration depth.

The total carbon content of the coated samples and uncoated silica sand particles was further determined by combustion infrared carbon detection technique deploying a LECO CS744 series carbon analyzer with a LECOCEL II and an iron chip accelerator. The major advantage of LECO over TGA is the capability to detect carbon composition exclusively while neglecting the degradation of other volatile matter components. The accelerator temperature and sample temperature were adjusted at 1800° C. and 1400° C., respectively. The amount of 1 mg of each sample was mixed with a volumetric unit of the accelerator prior to each analysis.

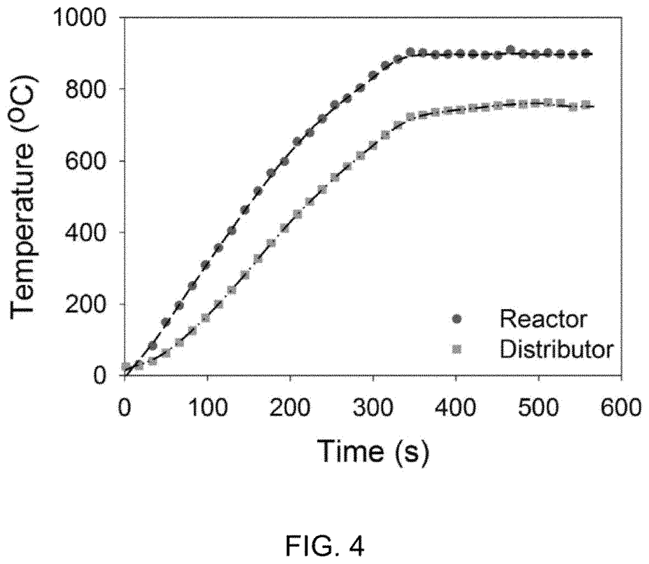

Resufts FIG. 4 presents the temperature profile of the middle of the bed and at the bottom of the distributor plate during the heating and FBCVD stages measure with the type K thermocouples. It is observed that a temperature gradient of approximately 130° C. existed between the bed temperature and the distributor plate. Taking into account the difference between the bed and the distributor plate materials together with the fluidized state of the bed, such a temperature difference inside the reactor would be expected. Furthermore, the distributor plate was located outside of the induction coil to minimize the thermal damages to the welded intersection of the plate and the reactor wall, which also explains its lower temperature. In addition, the reaction zone was insulated with quartz fiber to minimize heat loss risk, while the distributor plate was located outside of the insulated area to prevent overheating and consequent damage. Moreover, since the operating temperature was close to the sand sintering temperature, a lower temperature value on the distributor plate diminished the risk of blockage.

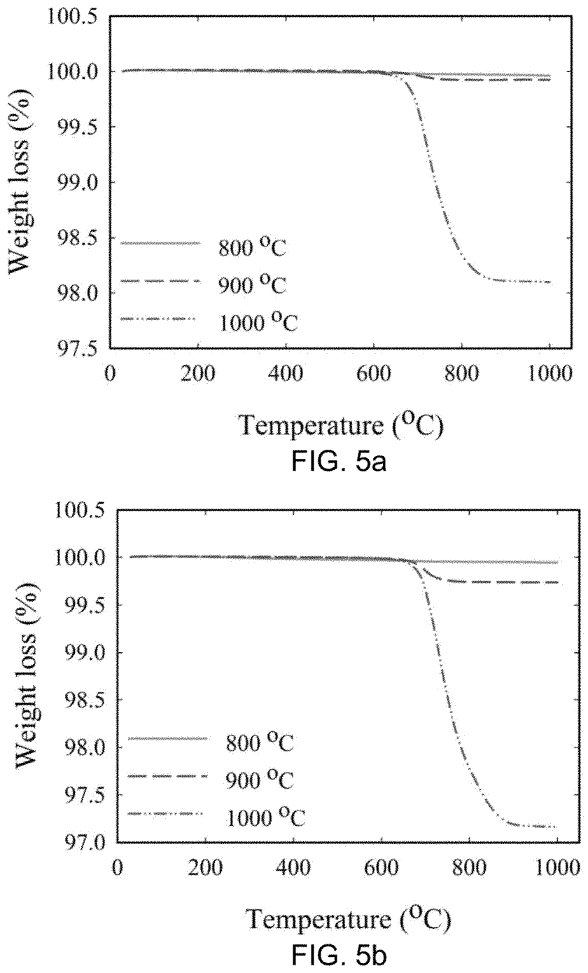

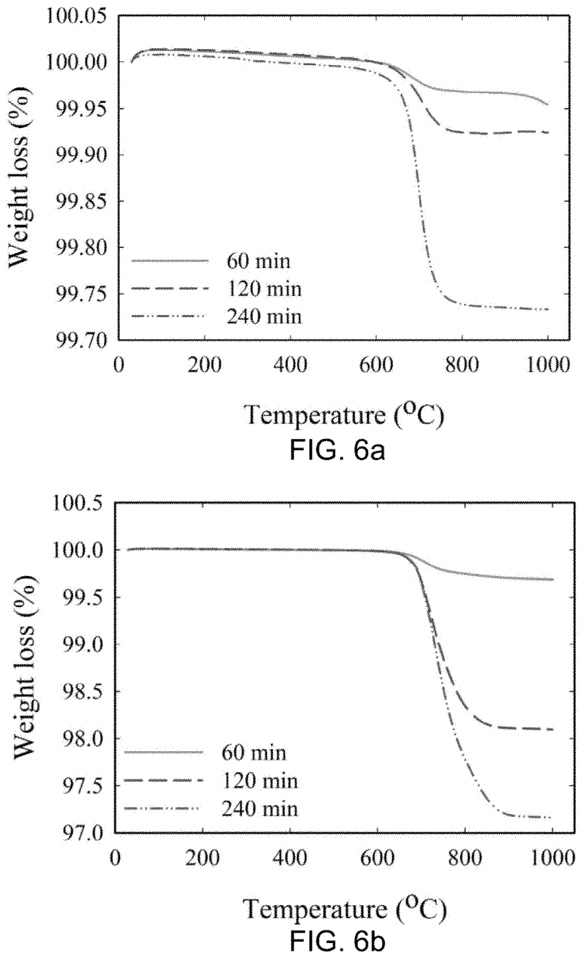

Regarding the characterization of the produced microwave receptors, the amount of carbon (microwave dielectric material) in the base silica sand material and carbon coated sand particles was determined by means of TGA and LECO tests as above-mentioned. The TGA curves under air of the uncoated sand particles and carbon-coated sand particles obtained at different methane thermal decomposition temperatures and reaction times are presented in FIGS. 5 and 6. The major weight loss step of the samples arose at temperatures between 600 and 800° C., which corresponds to the degradation of carbon-coated material deposited on the sand particles. FIG. 5 also presents the thermal behavior of the carbon coated sand particles in air, clearly showing that the coated layer of carbon would tend to dissipate if the coated sand particles were exposed to an oxidative reaction environment at temperatures above 600° C. The TGA results under nitrogen did not reveal any significant weight loss step, which indicates a negligible content of moisture and volatile matter in the samples.

TABLE 1
TGA and Combustion Infrared Carbon Detection (LEGO) Results for the Original
and Coated Particles at Various Coating Times and Temperatures

| Temp (° C.) | Sand | 800 | | | 900 | | | 1000 | | |
|---|---|---|---|---|---|---|---|---|---|---|
| Time (min) | N/A | 60 | 120 | 240 | 60 | 120 | 240 | 60 | 120 | 240 |
| TGA (% C) | 0.02 | 0.04 | 0.05 | 0.06 | 0.05 | 0.09 | 0.27 | 0.31 | 1.90 | 2.84 |
| LECO (% C) | <0.01 | <0.01 | <0.01 | 0.02 | 0.01 | 0.1 | 0.25 | 0.27 | 1.83 | 2.75 |

Table 1 summarizes the carbon content investigation of the prepared samples according to the TGA results. The TGA results have verified that the amount of carbon deposition on the substrate material is a function of reaction time and temperature. Increasing the coating temperature and/or reaction time considerably affects the carbon production and deposition on the sand material, although the effect of temperature is more significant.

Furthermore, the carbon composition of the bed sand material and coated particles produced under different coating times and temperatures was measured using combustion infrared carbon detection technique (LECO) as mentioned above. The results were in compliance with the TGA investigation to confirm the effect of time and temperature condition on the final carbon coating composition. The results of combustion infrared carbon detection are compared with the equivalent TGA data in Table 1.

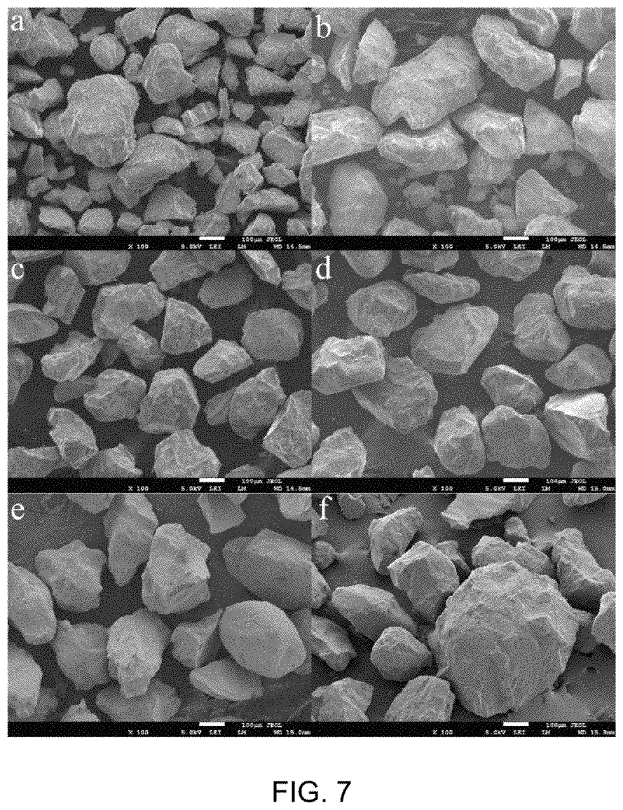

The SEM observations for the morphological investigation of the bed sand material and carbon-coated sand particles produced under different coating times and temperatures are presented in FIG. 7. The charging effect on the particles indicates absence or poor presence of carbon on the surface; on the other hand, increased carbon deposition and uniformity of the layer gradually diminishes the reflections. The SEM-FEG results precisely present a graphical analysis of the effect of time and temperature on the quality of the carbon coating on the sand substrate particles. While initially a poor, heterogeneous and negligible coating of carbon on the sand particles was observed for 800° C. and 60-min coating temperature and time respectively, the evolution of the coating layer uniformity was gradually observed by increasing the reaction time and temperature.

The morphological analysis indicated that the coating quality and uniformity was poor in all samples produced under a temperature of 800° C., indicating the low carbon production through TDM at temperatures below 900° C. and in the absence of a catalyst.

Moreover, all coating grades obtained for 60-minute reaction time, in general, show poor carbon coating, which indicates a strong effect of reaction time on carbon production and deposition during the TDM. However, by increasing the reaction temperature to 900° C., the rate of carbon production and deposition are considerably increased, leading to higher grades of coating due to the higher rate of methane degradation at high temperatures even in the absence of a catalyst. In addition, increasing the reaction time provides higher methane thermal exposure, which ultimately leads to higher carbon production and deposition on the sand particles.

Ultimately, for the samples produced at 1000° C. and 240-minute reaction temperature and time, respectively, the rate of carbon production is substantially higher than the rate of carbon deposition leading to the presence of carbon agglomeration particles in the sample, which are evidently observed by the SEM imaging. Observations of the thickness of the carbon coating layer and the location of multiple layers were facilitated by the focused ionized beam (FIB) milling of the samples produced at 800, 900 and 1000° C. temperature and 240-minute reaction time.

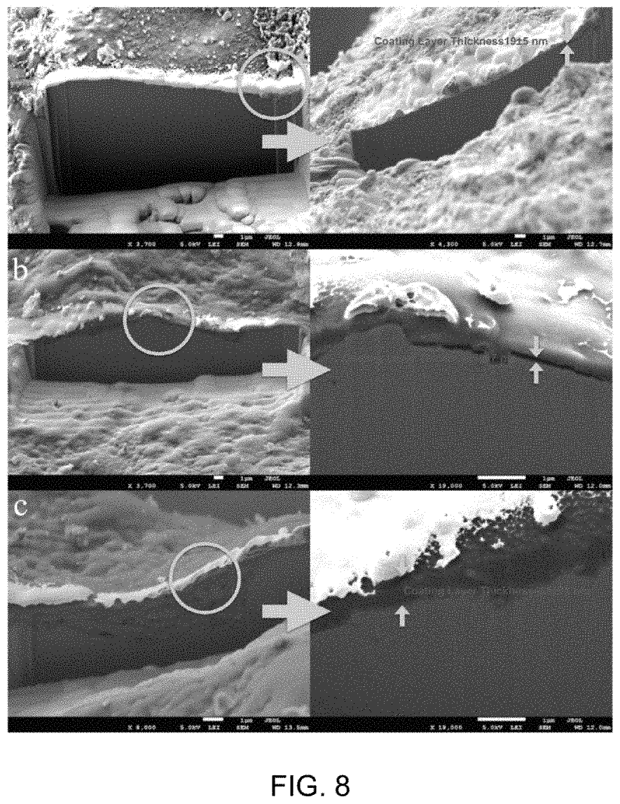

FIG. 8 illustrates the evolution of carbon as a function of coating layer thickness via temperature by means of FIB milling and SEM imaging. SEM observations noticeably approved the growth of the coating layer in terms of thickness by increasing the TDM temperature from 800 to 1000° C. The mean value of the carbon coating layer thickness at 800, 900 and 1000° C. FBCVD temperature and 240-minute reaction time was evaluated by ImageJ software and statistical analysis. Accordingly, 20 measurements were implemented on each SEM image at the FIB milling intersection by ImageJ built-in function; the mean values and standard deviation values are highlighted in FIG. 8, respectively.

Ultimately, EDX analysis was used to identify multiple layers at the FIB milling intersection, to investigate the composition and uniformity of coated layers thoroughly.

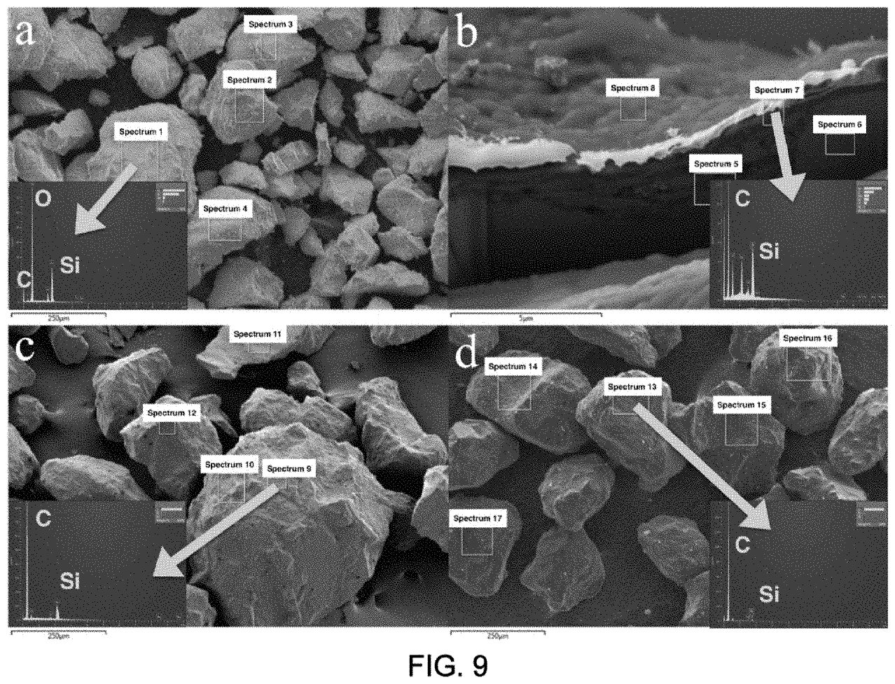

The EDX results revealed that increasing the temperature can extensively increase the carbon content of the coating layer. Moreover, the coating evolves to a more uniform layer as EDX identifies lower traces of Si and O, the principle elements of the core sand material, while elevating the coating temperature from 800 to 1000° C. FIG. 9 and below Table 2 present the EDX results and spectrum analysis of multiple local investigations for the substrate sand and various coated particles. Below Table 3 compares the surficial elemental analysis of the substrate sand material and coated sample grades at 800, 900 and 1000° C. reaction temperatures and 60-, 120- and 240-minute reaction times obtained by XPS analysis. The surface analysis of the samples revealed an elevation in the carbon content and a decrease in the Si and O elements while increasing the temperature and/or reaction time. However, the influence of the thermal effects is far more dominant. Moreover, the XPS results verified the presence of metals such as Al, in the core sand composition.

Although the coating quality is noticeably poor at initial 800° C. and 60 minutes TDM conditions, confirmed by the core sand elements detection on the surface, namely Si, O, and metals, carbon is the dominating element on samples obtained at higher temperature and longer reaction time, with values reaching above 90%. The inability of the XPS analysis to detect impurities and core sand composing material indicates a more uniform deposition of the carbon layer on such samples. The characterization observations revealed that very uniform and thorough layers of carbon could be deposited by induction heating FBCVD provided that appropriate reaction temperature and time were applied.

### EXAMPLE 2

### Microwave Heating Performance of the Carbon-Coated Sand Receptors Prepared in Example 1

Microwave Assisted Heating Setup

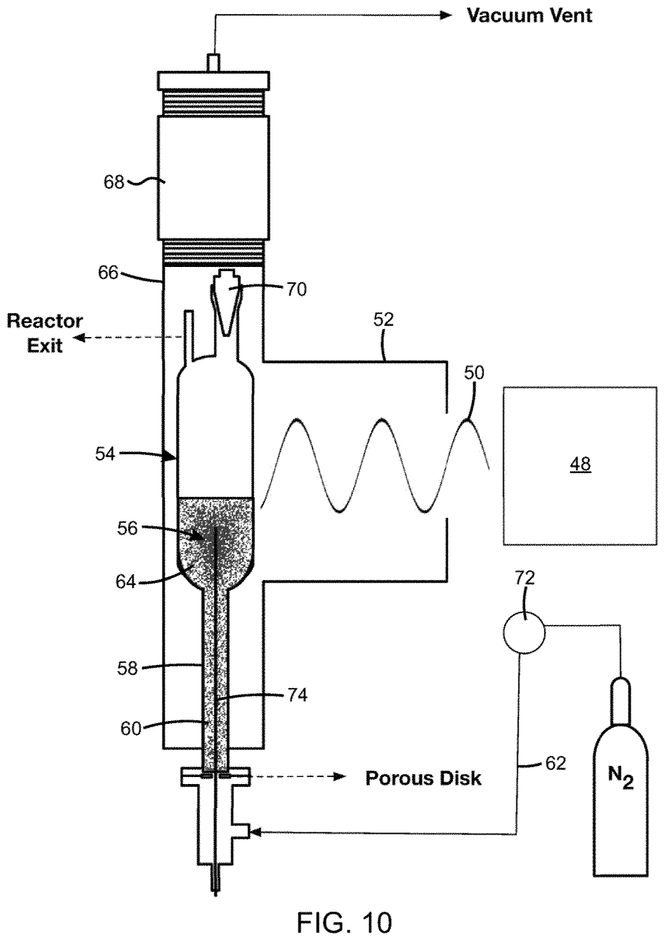

The heating performance and operational durability of all samples were tested in a fluidized bed microwave heating apparatus according to the setup diagram presented in FIG. 10.

A 2.5 kW, 2.45 GHz Genesys Systems microwave generator (magnetron 48), including a water-cooling unit, was employed for microwave generation during the heating stage. The generated microwave (50) was transferred from the magnetron (48) to the cavity position through rectangular brass waveguides (52). A 2.5 cm OD and 8 cm length tubular quartz reactor (54) was designed and manufactured to transmit the microwave (50) into a reaction zone (56) operating as a transparent medium. In order to eliminate the application of a distributor plate for gas flow dispersion, the quartz reactor (54) was attached to a 6 mm OD and 10 cm length lift-tube (58) at the bottom. The lift-tube was filled with coarse sand particles (60), of 700-800 micrometer size range, to uniformly distribute a flow of nitrogen (62) to the microwave receptor bed material (64), restrict gas jet formation and channeling effects, and support the bed material (64). The quartz reactor (54) and bare silica sand (60) projected no interaction with microwave radiation (50) throughout the operation, verifying that the heating effect was solely associated with the bed particles (64). The quartz reactor (54) was positioned inside a brass-copper alloy tubular electromagnetic shield (66) to restrict the microwave leakage within the operating environment. A removable cap (68) was mounted on top of the shield tube (66) for sample loading, maintenance and piping purposes. All metal parts were located outside of the microwave shielding, eliminating the risk of interaction and arching effects.

Protocole

Initially, 30 g of each sample listed in Table 3 was loaded through the quartz-fitting opening to the reactor (54), where the fitting was blocked by a quartz cap (70) prior to the microwave heating activation. Next, the magnetron (48) output current was adjusted using the controller knob, adapting the dissipated power, which ultimately led to the heat generation. Nitrogen was used as the fluidizing and carrier gas (62), while the superficial gas velocity was maintained through a mass flow controller (72) (Bronkhorst F-201CV). In order to restrict the fluidization regime to the bubbling region and prevent particle entrainment, as in the FBCVD setup of FIG. 3, gas velocity was reduced at elevated temperatures. The particles were heated under constant current of 0.2 Amps from room temperature to 500° C., while the bed temperature, heating time and gas velocity were monitored and recorded by LabView software. Each sample was submitted to three heating experiments to study the effect of surficial erosion on the operational durability of the samples. Moreover, the microwave heating performance of 800, 900 and 1000° C. samples at 240 min was furthermore tested at 0.1 and 0.3 Amps magnetron input current respectively to investigate the effect of microwave power on the temperature profile. The dissipated power and reflected power were continuously monitored during the experiments employing an analog power meter. The reflected power was transferred and dissipated using a one-way air-cooled fin to prevent the magnetron (48) from overheating. The fin temperature was continuously monitored by a type K thermocouple (74).

To determine the performance capability of the coated samples versus manual mixtures of sand and graphite, 1%, 5%, 50% and 90% weight fractions of graphite to sand mixtures were prepared and 30 mg of each sample was tested in the microwave setup. Each sample was extensively mixed prior to evet experiment individually. The tests were performed at 0.1, 0.2 and 0.3 Amps for each graphite-sand mixture sample, accordingly. The quartz reactor was removed and thoroughly cleaned following the cooling down stage under purged nitrogen. The type K thermocouple located inside the reactor was further electrically grounded to eliminate the thermocouple effects and microwave interaction leading to temperature measurement uncertainty.

Results

Although low traces of carbon are observed in uncoated sand particles, as reported in Table 3, these particles did not experience any significant interaction with microwaves; this implies that such a low amount of carbon is not sufficient to counteract the poor dielectric properties of the main constituting elements of sand. The poor interaction of uncoated sand with microwaves emphasizes the importance of developing an effective receptor material for microwave heating applications.

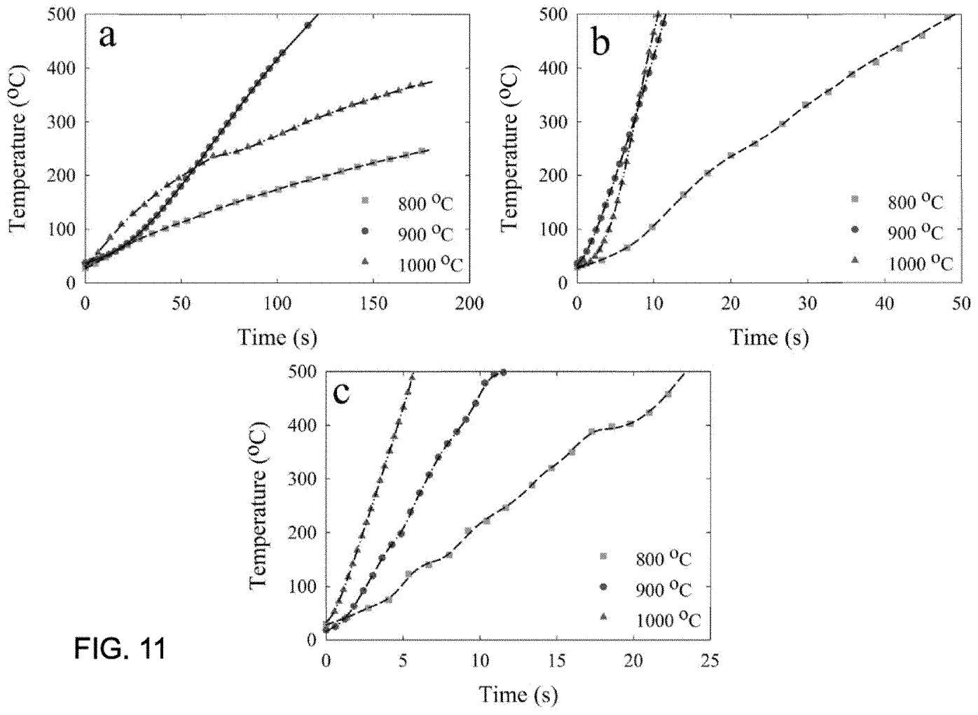

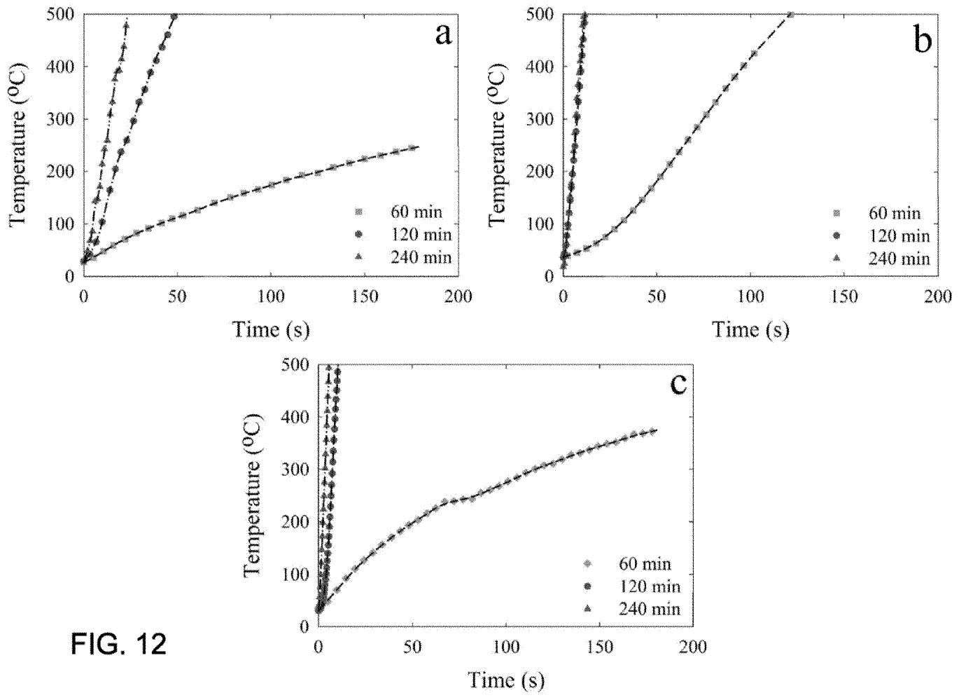

FIGS. 11 and 12 illustrate the heating profile of coated samples from room temperature to 500° C. while exposed to microwaves at 0.2 Amps power cycle produced under different TDM reaction times and temperatures in the setup of FIG. 10. It was initially observed that because of the low coating uniformity and carbon deposition, for samples produced under short reaction times particularly 60 minutes, the receptor material did not compensate for the poor dielectric properties of the core sand particles. Consequently, even at prolonged microwave exposure periods, the temperature failed to reach the designated 500° C. value, resulting in a low heating rate and insufficient microwave absorption.

However, enhancing the TDM operating conditions and consequently increasing the carbon deposition rate, which was verified by TGA and LECO results and coating thickness and uniformity, demonstrated by SEM, FIB and EDX results, greatly increased the heating rate for a constant microwave power. Furthermore, observed heating profiles for samples produced at FBCVD operating conditions leading to low carbon deposition and poor coating layer uniformity demonstrate that the microwave heating was constantly interrupted, as shown by broken lines in FIGS. 11 and 12. Consequently, both the amount of carbon and the uniformity of the coating proved to be crucial to promote the microwave heating performance of the receptors. The enhanced and uniform coating at higher TDM temperatures and reaction times not only promotes the dielectric properties of the microwave receptors, but also creates a network of carbon nano-layers which boosts the electron interchange by boosting the conductivity, leading to the superior microwave heating performance of the coated receptors.

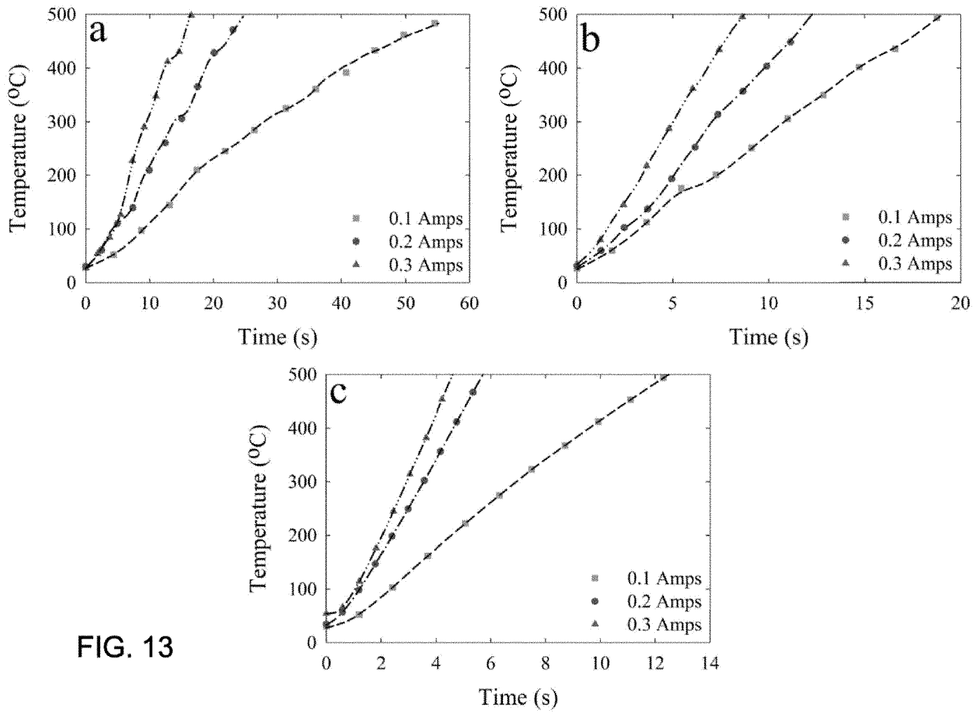

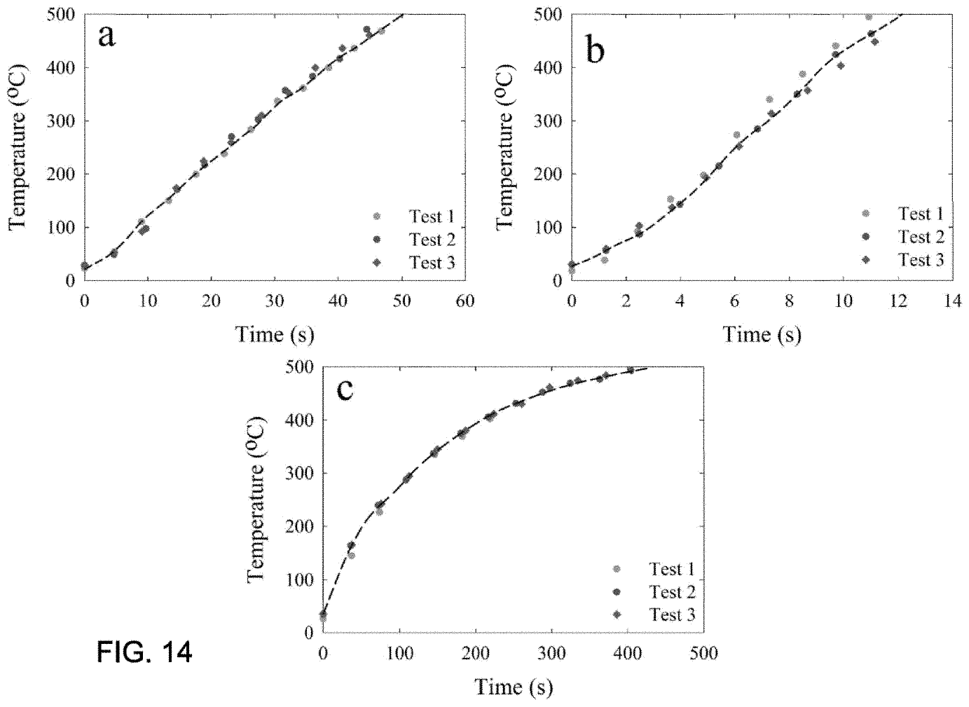

Furthermore, coated sample grades produced at 800, 900 and 1000° C. TDM temperature and 240 reaction time were exposed to microwave at 0.1, 0.2 and 0.3 Amps power cycle to investigate the effect of microwave power on the heating mechanism of the receptor materials. As depicted in FIG. 13, the results were in compliance with the general rules of microwave heating, i.e. that increasing the microwave power has a significant effect on enhancing the heating rate of the dielectric material. The same trend was observed for all the coated sample grades covering the complete FBCVD production temperature range. In addition, the attrition resistance and durability of the receptor material in a gas-solid fluidized bed while exposed to the microwave was tested thoroughly by repeating the heating performance tests three times for each sample. In each test, the samples were heated to the designated 500° C. temperature and subsequently cooled down to 25° C. under nitrogen purge, while the bed was fluidized. The results are presented in FIG. 14. If the receptor material had not been sufficiently resistant to attrition, their microwave heating performance would have deteriorated due to reduction in the cross-linking bridge for electrons to travel within the carbon layer. Also, damaged and detached carbon layers would have segregated to the surface of the fluidized bed, resulting in poor interaction of the bed material with the microwave.

Following the observations, it was concluded that submitting the receptor material to multiple heating and cooling cycles did not seem to affect the heating capabilities of the coated particles. However, longer exposures with multiple cycles will be carried out to confirm the results.

In order to evaluate and compare the heating performance results from the developed microwave receptors, 1%, 5%, 50% and 90% weight fractions of graphite to pure sand mixtures were prepared and exposed to microwave radiation in the fluidized bed. Graphite has been widely regarded as the most outstanding dielectric material with exceptional microwave intractability among the carbon receptor criteria; hence the comparison provides a high-level qualitative evaluation of the characteristics and properties of the developed receptor material. All the experiments aimed at heating the bed material from 25° C. to 500° C. The results are disclosed in FIG. 15.

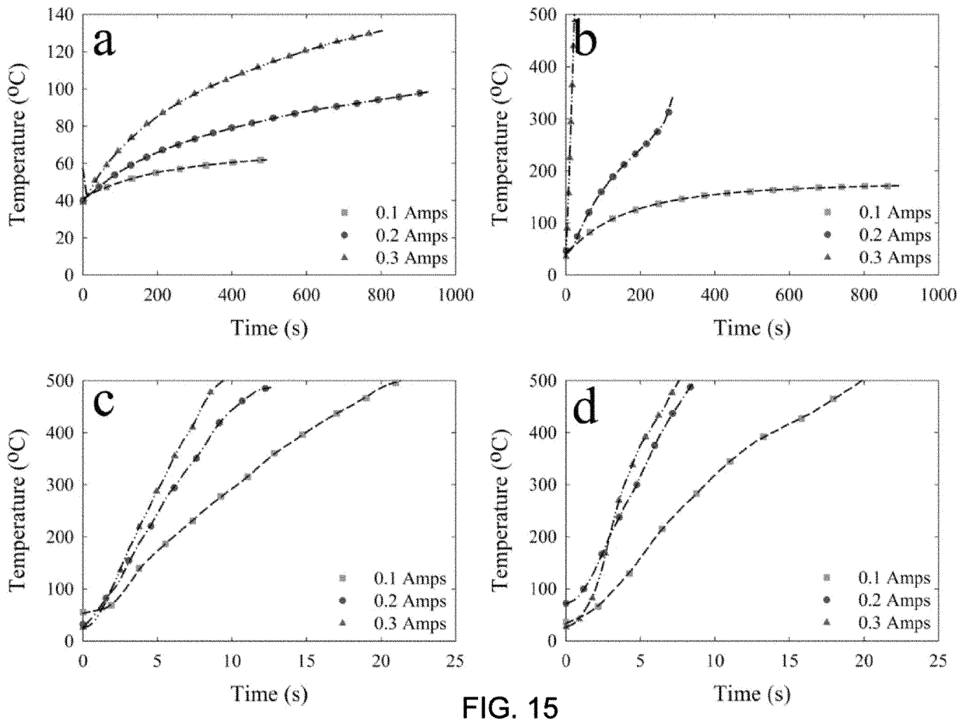

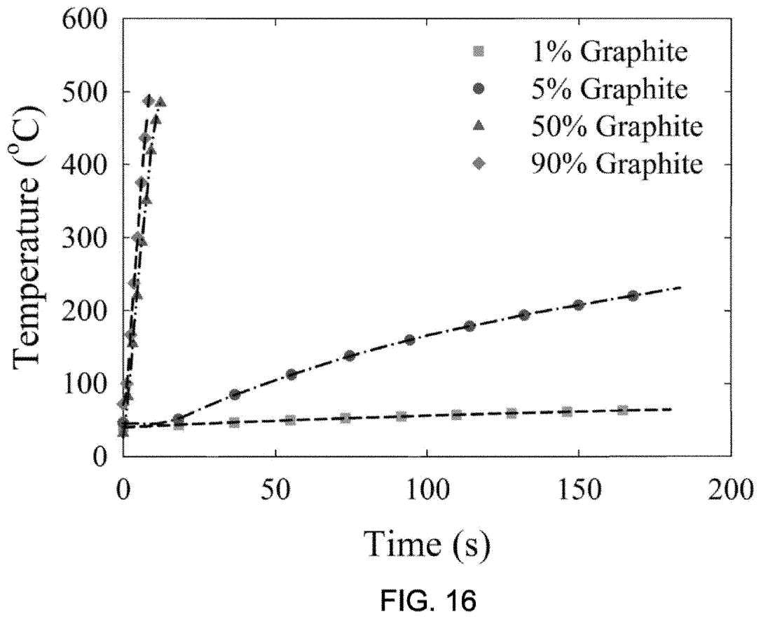

FIG. 16 presents a comparative microwave heating performance of 1%, 5%, 50% and 90% graphite to sand mixtures exposed to 0.2-Amp power cycle. All the experiments were implemented from 25° C. to 500° C. correspondingly. The investigation disclosed that at low graphite content namely, 1% and 5%, even by increasing the microwave power, the mixture did not possess satisfactory dielectric properties to enable the bed reach the designated temperature even at prolonged microwave exposure. However, increasing the graphite content of the bed significantly improved the heating performance of the mixtures with comparable outcome to the developed microwave receptors obtained at high FBCVD temperature and reaction time.

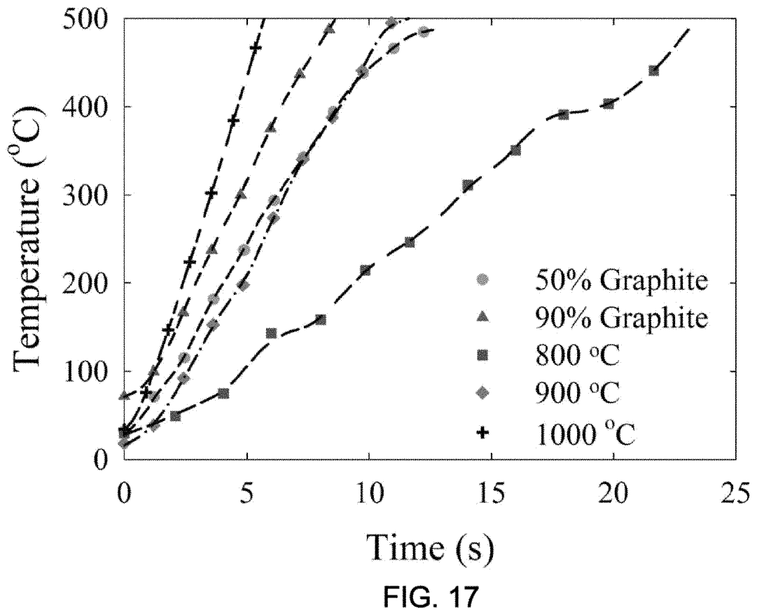

It is noteworthy that the best performing graphite/sand mixture contained 90% of carbonic material, while the highest rated carbon coated receptor, obtained at 1000° C. temperature and 240-minute period of FBCVD, contained 2.8 wt% of carbon. In addition, the developed receptor still exhibited a higher heating rate compared to graphite/sand mixed bed experiments. Moreover, while the coated sample produced at 900° C. and 240 minutes coating temperature and reaction time, respectively, had a carbon composition below 0.3%, the coated sample still exhibited a significantly higher heating rate while exposed to microwave radiation as compared to the competitive graphite/sand bed mixture material. FIG. 17 shows the microwave heating performance of carbon-coated sand receptors at 800, 900 and 1000° C. and 240 minutes TDM temperature and time, compared to 1%, 5%, 50% and 90% graphite to sand mixtures at 0.2 Amps microwave power cycle.

Correspondingly, it appears that the effect of coupling the carbon receptor with the bed material has a much more substantial effect than simply increasing the carbon composition of the bed, suggesting there is an enhanced coherence between the carbon layers that facilitate the travel of electrons through vacant orbitals of carbon, thus increasing microwave interaction efficiency. Moreover, pairing the carbon and sand bed material minimizes the risk of segregation, which diminishes the temperature gradient within the bed. Consequently, with a significantly low levels of carbon content of below 3 wt % a coating uniformity that leads to a network of carbon and nano-layers, a coating durability and erosion resistivity, the novel carbon coated sand receptors are remarkably superior to the competitive graphite/sand mixtures in their microwave heating performances.

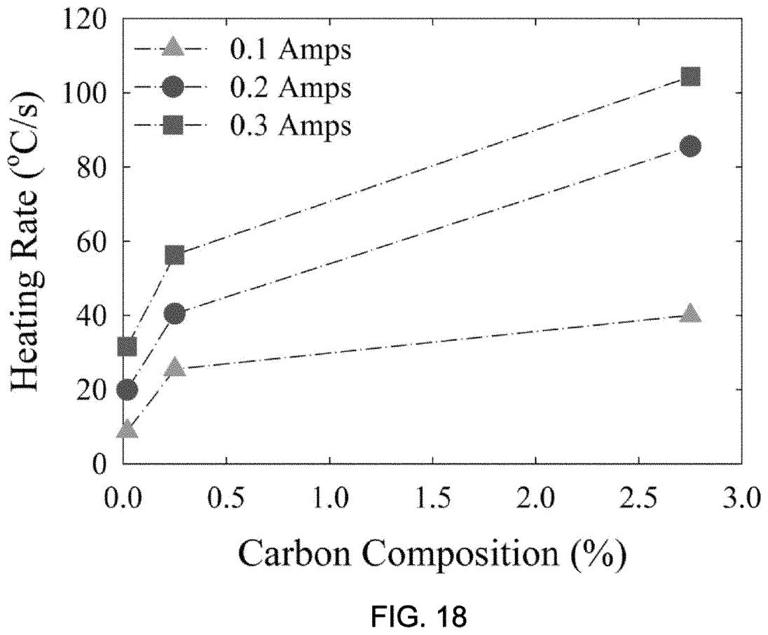

Moreover, heating rate efficiency of the developed microwave receptor material as a function of carbon content and microwave power, was investigated. The results are illustrated in FIG. 18. The heating rate data were acquired from FIG. 13 using a linear curve fitting. Initially, with a microwave power corresponding to 0.1 Amps cycle current, which is a very low output, the measured heating rates are drastically low, highlighting the requirement for a minimum microwave power in order to produce adequate heating rates. However, when the microwave power was increased above 0.2 Amps, all coated samples demonstrated a significantly higher heating rate, which is in compliance with microwave heating principles. Furthermore, an increase in carbon content deposition led to the generation of higher heating rates for receptors while exposed to microwave radiation, which is in accordance with carbonic compounds as substantial dielectric materials for microwave heating purposes.

The advantage of the observed extreme heating rates could be exploited in the reduction of process time and improved kinetic rates. The thermal requirements of endothermic reactions, biomass gasification and partial oxidation, for instance, lead to an enormous temperature drop in the reaction system. Consequently, the present techniques would compensate for the temperature fluctuations, thereby preventing the production of undesired by-products and promoting the selectivity of the desired components.

The combination of the specific characteristics of the developed microwave receptors with the negligible interactivity of gaseous components with microwave radiation provides an opportunity for the carbon coated particles to be used as catalyst or catalyst support to optimize gas-solid catalytic reactions.

### EXAMPLE 3

### Demonstration of the Gas and Solid Phase Temperatures Profiles

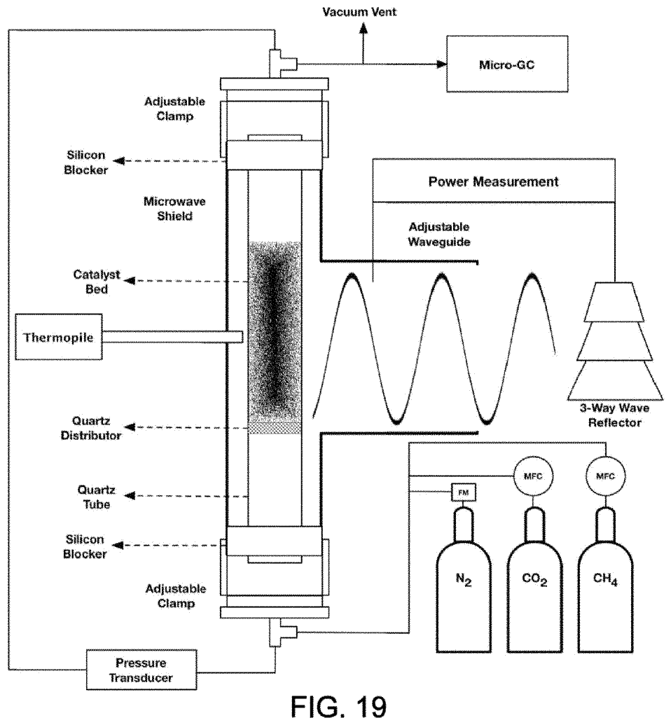

Microwave intractability of the formed carbon-coated sand particles was successfully investigated with the apparatus assembly illustrated in FIG. 19 which includes a single-mode industrial magnetron with automatic power control. This setup was designed to observe the erosion, durability and general performance of the modified bed particles in a fixed bed reactor and a fluidized bed reactor. Using C—SiO₂ receptors (bed particles) produced in Example 1 as the solid phase, and nitrogen as the gas phase, temperature measurements of the solid surface and bulk, a contributive state of the solid and gas phases were performed.

More particularly, using the setup illustrated in FIG. 19, microwave radiation was generated by a 2.5 KW and 2.45 GHz frequency water-cooled Genesys system magnetron and transferred to a 20-cm height and 2.24-cm ID quartz tube reactor. A 3-way wave reflector is used to prevent the non-dissipated wave from returning to the magnetron and damaging it. The temperature of the solid surface of the bed material (referred to as receptor bed) was monitored using a radiometry light capturing device called a thermopile. The thermopile was calibrated to record the surface temperature of the dielectric and catalytic particles based on the amount of irradiation received by exposing the particles to the electromagnetic field. However, the direct measurement of the gas temperature through the bed was extremely complex due to the physical and chemical properties of gaseous components in general. Consequently, thermometric methods were used to measure the temperature of a solid phase and a bulk phase, which is a cumulative median phase contributed by the gas and solid phase simultaneously.

For each experiment, 30 g of the receptor samples (Example 1, Table 2) were loaded to the reactor. The experiments were performed in 3.4 cm/s, 6.7 cm/s and 10 cm/s and 500, 600 and 700° C. superficial gas velocities and particle surface temperatures, respectively. The temperature measurement of the dielectric solid particles (C—SiO₂) and bed bulk was performed using radiometry and thermometry methods, respectively.

Results

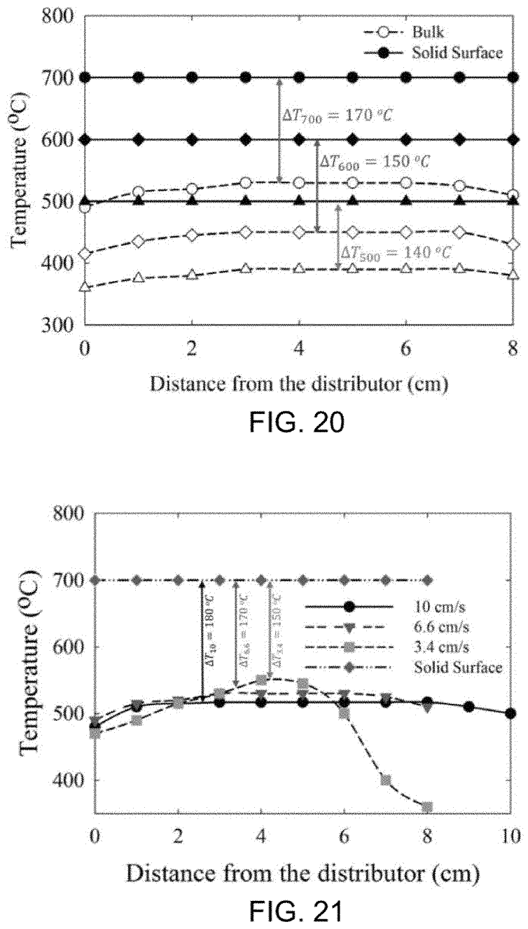

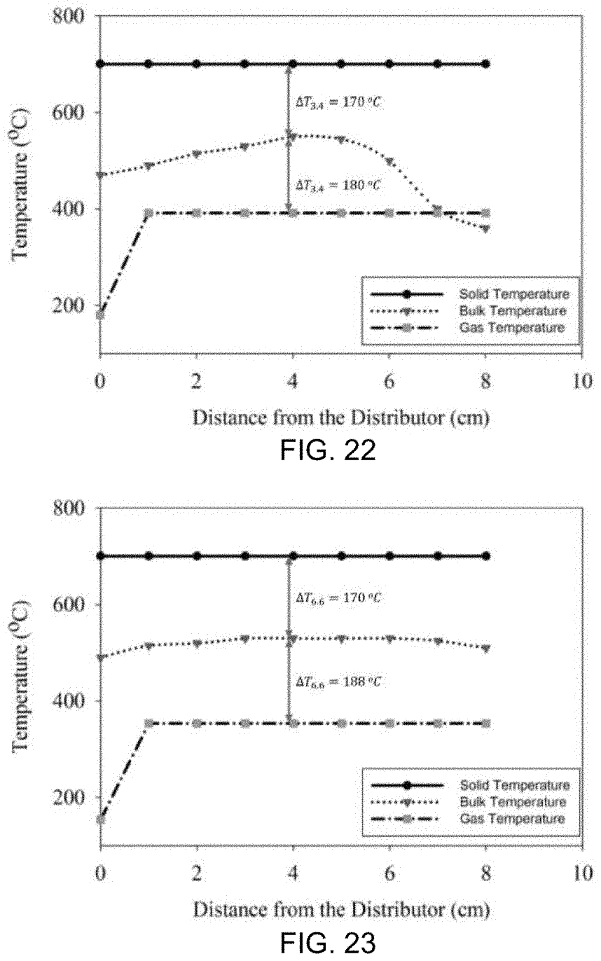

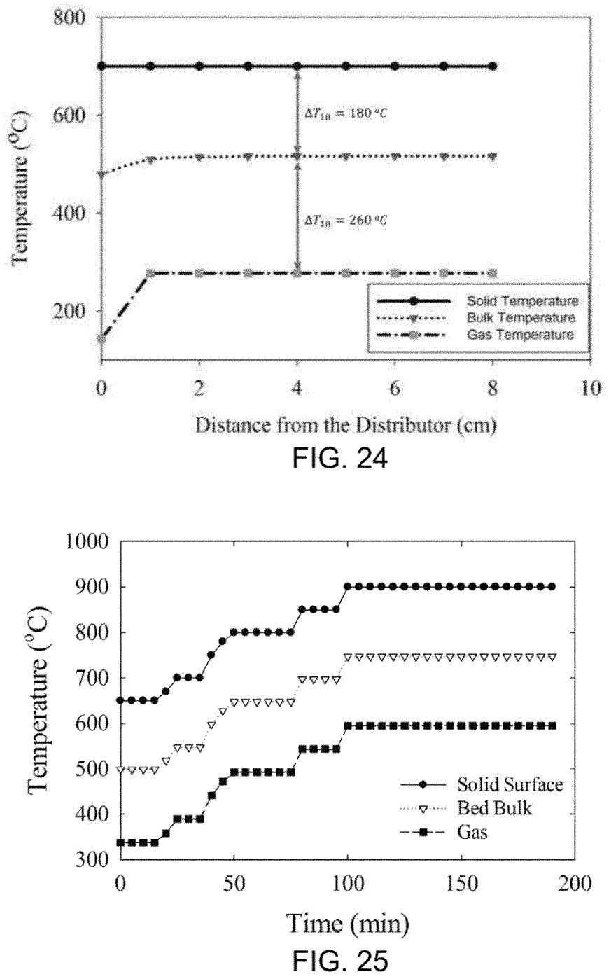

FIGS. 20 and 21 respectively illustrate the effect of a variation of the operating temperature and superficial gas velocity on the temperature gradient. Studying the thermal behavior of the solid and bulk phases revealed a significant gradient between the temperature distribution in these phases as better seen on FIG. 20. The measured temperature gradient demonstrates the anticipated lower temperature of the gas phase compared to the solid particles. The effect of the gas superficial velocity and the particle surface temperature was later verified on the extent of the intra-phase temperature gradient as better seen on FIG. 21. Thermometry is used for the bulk temperature measurement and radiometry (thermopile) is used for the solid surface measurement. The effect of the superficial gas velocity and the solid surface temperature on the temperature gradient between solid surface and bulk was investigated. It was proven that at lower gas higher gas velocities and temperatures such gradient significantly enhances. Using hydrodynamic data and the investigated thermal study conclusions, a two-phase model was developed to estimate the gas phase temperature distribution along the bed in the reactor. The model verified a massive gradient between the gas, bulk and solid temperature distribution in a microwave heating reactor which was further governed by the gas superficial velocity and particle surface temperature accordingly as seen on FIGS. 22 to 24.

As seen in FIG. 25, the experimental data and the estimated correlations results demonstrated a remarkable temperature gradient between the gas and the solid phase at operating conditions corresponding to dry reforming of methane (DRM). These measurements reaffirm the hypothesis that the productivity of the catalytic gas-solid reactions is enhanced due to the localized temperature of the catalyst surface being significantly higher than the gas phase.

### EXAMPLE 4

### Production of a Supported Catalyst

Experiments, including microscopic surface analysis and components detection tests, have been performed to study ultrasound-assisted incipient wetness impregnation to deposit metal containing species on the graphite-coated silica sand particles.

As the graphite coating does not have sufficient porosity (or SSA), the graphite-coated sand particles cannot be used as catalyst support in traditional incipient wetness impregnation processes. Thus, the C—SiO₂ particles were considered as a suitable low specific surface area material candidate to study ultrasound-assisted incipient wetness impregnation.

Nickel was selected as the metal species to be deposited on the graphite-coated silica sand particles due to the diversity of potential applications. Nickel was provided in the form of nickel nitrate as a precursor (catalyst active phase) and graphite-coated silica sand (C—SiO₂) was employed as the solid support material. Several surfactant liquid medium including water (W), oleic acid (OA), hexane (Hx) or a mixture of hexane and oleic acid, were tested for the ultrasound-assisted deposition experiments.

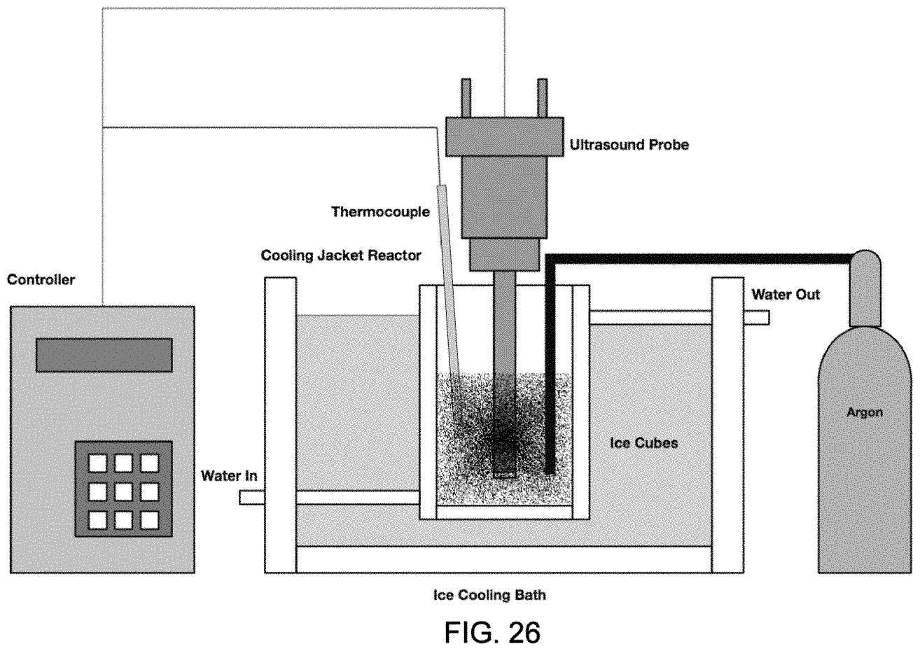

Referring to FIG. 26, the ultrasound-assisted deposition experiments included an ultra sound probe and a stirred water cooled reactor operating at room temperature and working in an operating range of 60% to 100% power cycle. An operating time of 2 hours with 1 second pulse generation and 1 second void time was used. Argon was purged to the reactor at an average of 100 ml/min to provide a better mixing. The ultrasonic processor included a piezoelectric converter operating at 20 KHz and 500 Was a nominal power. The piezoelectric converter was connected to a ultrasonic titanium horn with a tip diameter of 13 mm. The operating temperature set was 0° C., but ultrasound heated the mixture at a temperature ranging from 20° C. to 30° C. depending on the solvent. A calcination stage carried out at 900° C. under a very low flow of hydrogen to activate the catalyst surface and prevent oxidization was included.

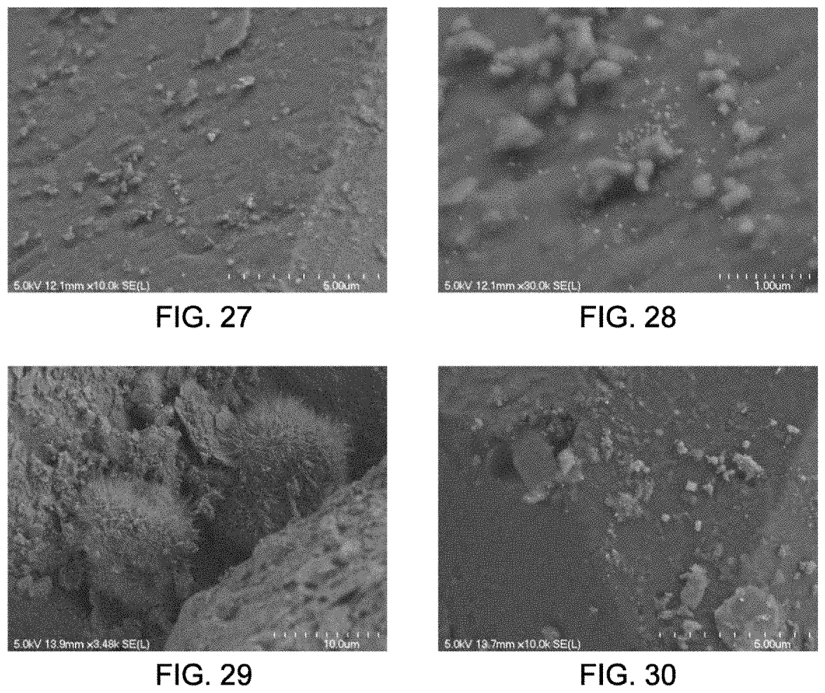

FIGS. 27 to 30 are SEM images of the resulting nickel deposit on graphite-coated silica sand (C—SiO₂) particles using ultrasound-assisted incipient wetting impregnation in water, so as to evaluate the quality of the nickel deposition on the support with water as the transfer medium. These images show that, due to high polarity, low dissolution of the nickel nitrate precursor and low viscosity of the medium (water), led to insufficient transmission of the ultrasound waves, and therefore negligible deposition of nickel on the support.

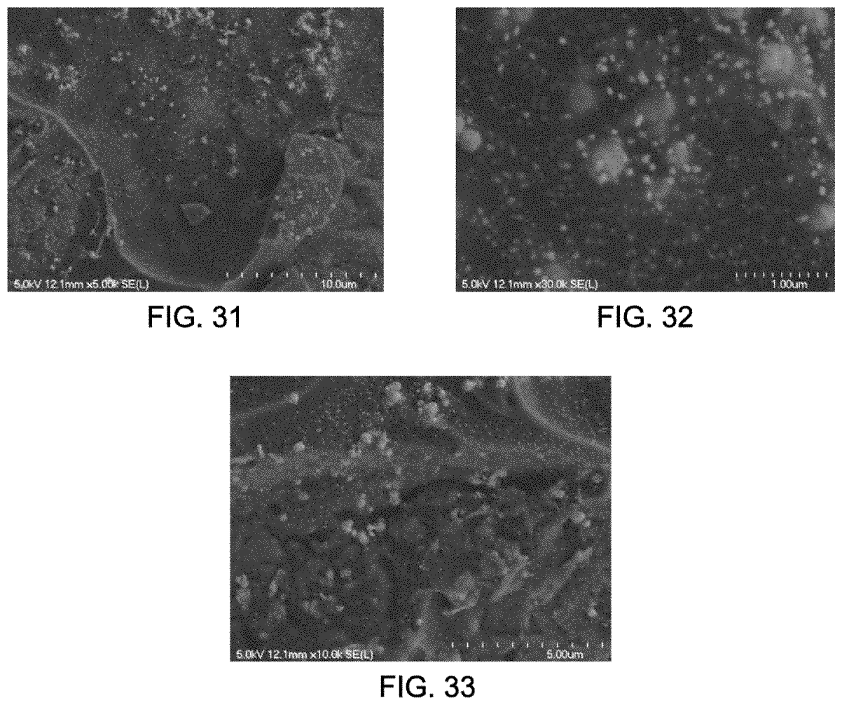

FIGS. 31 to 33 are SEM images of a nickel deposit on graphite-coated silica sand (C—SiO₂) particles using ultrasound-assisted incipient wetting impregnation in oleic acid as transmission medium. Using similar reaction conditions as per FIGS. 27 to 30, it was revealed that the deposition has been significantly enhanced. 0.2% deposition of nickel was observed. Non-uniform deposition of nickel may however be due to extreme viscosity of the oleic acid and low mixing of the particles inside the reactor.

Additional experiments of ultrasound-assisted deposition of nickel over the low specific area support was implemented for different medium ratios to investigate the effect of the surfactant on the quality and quantity of the deposition results. The nickel content of the samples after deposition and calcination were determined with atomic adsorption method. Table 4 provides these deposition conditions and results for the seven samples.

TABLE 4

| Sample | | W | | W | | P | t | | Flow | | V | Adsorption |
|---|---|---|---|---|---|---|---|---|---|---|---|---|
| # | Catalyst | (g) | Support | (g) | Pulse | (%) | (hr) | Gas | (ml/min) | Solvent | (ml) | (%) |
| 1 | Ni | 24.7 | SiC30800240 | 27.1 | 1&1 | 60 | 2 | Ar | 80 | W | 300 | 0 |
| 2 | Ni | 29.5 | SiC27900240 | 29.4 | 1&1 | 60 | 2 | Ar | 100 | Hx | 250 | — |
| | | | | | | | | | | OA | 50 | |
| 3 | Ni | 22.7 | SiC36900120 | 27.4 | 1&1 | 60 | 2 | Ar | 100 | Hx | 110 | — |
| | | | | | | | | | | OA | 30 | |
| 4 | Ni | 23.4 | AlC57900240 | 23.9 | 1&1 | 60 | 2 | Ar | 100 | Hx | 110 | 0.1 |
| | | | | | | | | | | OA | 40 | |
| 5 | Ni | 25.7 | SiC60900240 | 30.2 | 1&1 | 100 | 2 | Ar | 100 | Hx | 160 | 0.2 |
| | | | | | | | | | | OA | 50 | |
| 6 | | | SiC60900240 | 10.8 | 1&1 | 70 | 2 | Ar | 110 | Hx | 110 | 0.0002 |
| | | | | | | | | | | OA | 30 | |
| 7 | Ni | 25.6 | SiC60900240 | 33.0 | 1&1 | 70 | 2 | Ar | 110 | Hx | 150 | 0.53 |

Table 4 shows that use of hexane as transfer medium led to the highest deposition of nickel on the substrate in the tested conditions.

### EXAMPLE 5

### Dry Reforming of Methane (DRM) Experimentations

Experiments have further been performed to study the effect of the microwave heating, during dry reforming of methane (CH₄), on the conversion of reactants (CH₄ and CO₂), selectivity of the primary products (H₂ and CO) and production of undesired secondary products through secondary gas phase reactions.

Setup

The DRM reactions were attained in a lab-scale single-mode microwave-heated fluidized bed reactor as illustrated in FIG. 10. The microwave radiation was generated by a 2.5 kW and 2.45 GHz frequency Genesys system magnetron with an internal water cooling mechanism and transferred to a 2.54-cm ID and 20-cm long fused quartz tube reactor (Extended Data FIG. 11).

Multiple catalysts, both self-developed and commercial were employed to catalyze the gas-phase DRM reactions. Due to the low initial microwave intractability of the catalyst particles at the ambient temperature, C—SiO₂ receptor particles were added to the bed according to a desired temperature. The receptor particles were added both as a catalyst support and as catalyst promoters mixed with catalyst particles in the same size range of 212-250 microns.

For each experiment, a mixture of 12 gr of the HiFUEL R110 (15-10% Ni, alumina supported) and 28 gr of the C—SiO₂ receptor/promoter (see Example 1) were loaded to the quartz reactor. The bed was fluidized by nitrogen with a superficial gas velocity of 3.3 cm/s to 10 cm/s depending on the system temperature to maintain a bubbling fluidization regime. The temperature of the solid particles was monitored with a thermopile. Due to the insufficient dielectric properties of the system components and the bed constituents, the C—SiO₂ receptors mitigated for the heat generation inside the reactor, exclusively.

The gas flow was switched to a CO₂/CH₄=1:1 following the accomplishment of the operating temperature and to emphasize the effect of microwave heating on the reaction mechanism solely. The exhaust gas was continuously monitored by a Varian CP-4900 micro gas chromatographer (GC) to detect the volumetric fraction of each component. The reaction was performed in a temperature range between 650° C. and 900° C. for a period during which the catalyst remained active.

### Results

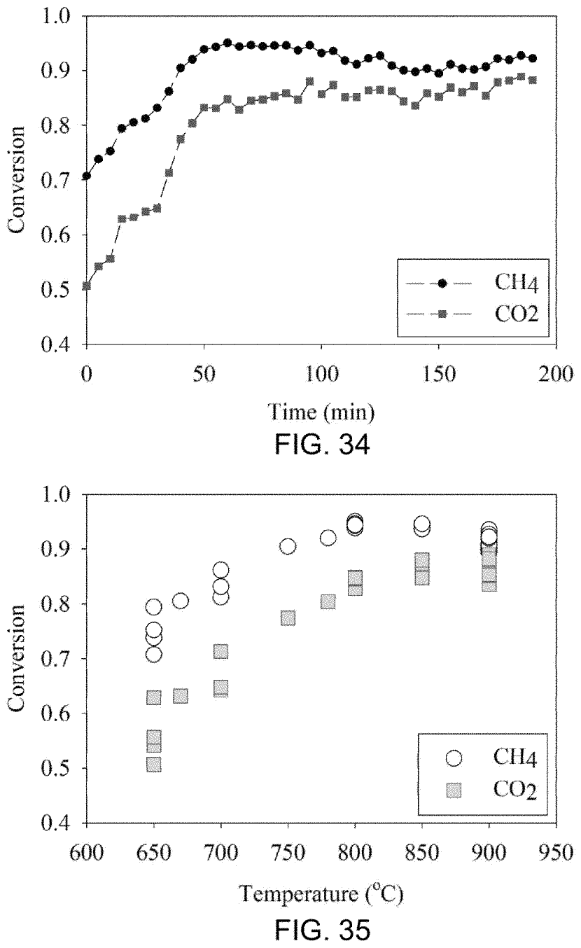

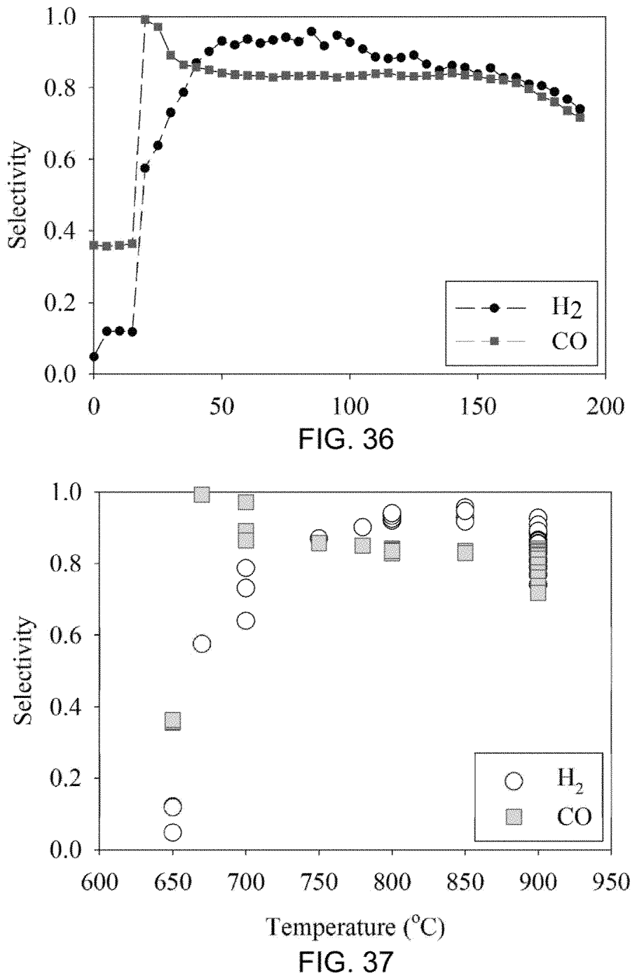

The results illustrated in the graphs of FIGS. 34 and 35 demonstrate the significance of microwave heating mechanism over conversion of the reactants. The results illustrated in the graph from FIGS. 36 and 37 demonstrate the selectivity of the products.

The CH₄ conversion ranged from 80% to a threshold of 95% and the CO₂ equivalent conversion from >60% to >85%. Such difference in the conversion of the reactants is due to the methane decomposition reaction and formation of carbon, even though at CO₂/CH₄ ratios of 0.5 to 1, CO₂ is typically the limiting reactant. Meanwhile, the selectivity of H₂ was enhanced up to 95% by increasing the DRM operating temperature prior to the catalyst deactivation. Moreover, at CO₂/CH₄ ratios of close to unity, the H₂ selectivity is further improved due to the persistent decomposition of methane. However, increasing the operating temperature diminished the H₂ selectivity enhancement due to the reverse water gas shift reaction. Moreover, the deactivation of the catalyst intensified at higher operating conditions contributed to a decline in the H₂ selectivity. In contrast, the CO selectivity reached a maximum value close to 100% at 700° C., but due to the formation of carbonaceous material on the receptor particles, the CO disproportionation reaction was enhanced as temperature increased. Consequently, due to the limitations of CO₂ reactions at CO₂/CH₄ ratios close to unity, the CO selectivity further encountered a distinctive decline period. However, at higher temperatures above 800° C., the CO selectivity recovered slightly due to the endothermic mechanism of the originating reactions. In general, the conversion of the reactants and the selectivity of the products exceeded the estimated thermodynamically predicted equilibrium values and the available studies in the literature.

The enhanced productivity of the DRM process is associated with the microwave selective heating mechanism, which significantly restricts the evolution of the secondary gas-phase reactions while maintaining a high conversion of the reactants and high selectivity of the syngas components.

The conversion of the DRM reactants CH₄ and CO₂ is enhanced by increasing the reaction temperature, which is in compliance with the endothermic nature of the reactions. Although the conversion of CH₄ is superior to carbon dioxide since CO₂ is the limiting reactant at CO₂/CH₄<1 (see FIG. 37), the syngas components, H₂ and CO, demonstrate an increasing trend for selectivity at higher operating temperatures. However, CO selectivity is maximum at 650° C. due to the dominance of the reverse CO disproportionation reaction at lower temperatures.

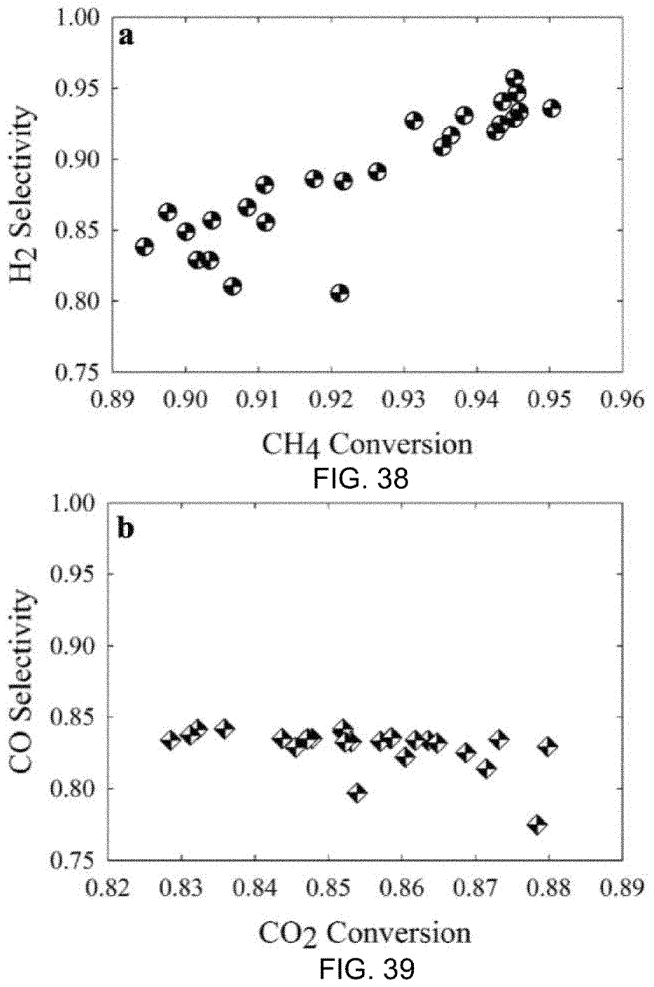

In general, while performing catalytic gas-solid reactions, the conversion of the reactants and the selectivity of the desired product are respectively inversely proportional due to the evolution of the secondary gas-phase reactions. However, the microwave dry reforming of methane maintained a high conversion of the reactants and selectivity of the syngas components at an operating temperature range of 800° C. to 900° C. (FIGS. 38 and 39). This can be explained by the microwave heating mechanism strictly restricting the production of undesired secondary products, by constraining secondary gas phase reaction which is due to the significant intra-phase temperature gradient.

The results established a superior productivity over the equivalent conventional process heating studies in the literature which required to compromise between the conversion and selectivity values.

1. A method for selectivity converting gaseous reactants into primary products over undesired secondary products, the method comprising:
providing a plurality of solid bed particles in a gas-solid reactor in presence of the gaseous reactants, each solid bed particle comprising a core and a dielectric coating deposited on a surface of the core;
irradiating the gas-solid reactor with microwaves for heating the dielectric coating of the solid bed particles, the dielectric coating locally transferring thermal energy to the surrounding gaseous reactants which are thereby selectively converted into the primary products.

2. The method of claim 1, wherein the core is made of silica, alumina, olivine, FCC, zeolite, quartz, glass a combination thereof.

3. (canceled)

4. The method of claim 1, wherein the dielectric coating is made of a metallic compound, a carbonaceous compound, or a combination thereof, and has a ratio of loss factor to a dielectric constant between 0.5 to 1.

5. (canceled)

6. The method of claim 4, wherein the metallic compound is titanium, vanadium, chromium, manganese, iron, cobalt, nickel, copper, zinc or an alloy thereof, and the carbonaceous compound is in the form of graphine, graphite or amorphous carbon.

7. (canceled)

8. (canceled)

9. The method of claim 1, wherein the solid bed particles are carbon-coated sand particles, for which the core of each solid bed particle is made of silica sand and the dielectric coating is made of carbon.

10. (canceled)

11. (canceled)

12. The method of claim 9, comprising producing the carbon-coated sand particles by thermal decomposition of methane to obtain a given amount of carbon, and chemical vapor deposition of the given amount of carbon as a carbon coating on the core.

13. The method of claim 12, wherein the thermal decomposition of methane and the chemical vapor deposition of the carbon coating are performed simultaneously in an induction-heated fluidized bed reactor.

14. The method of claim 13, comprising controlling a reaction time and temperature within the induction-heated fluidized bed reactor to obtain a uniform carbon coating of a desired thickness over the core.

15. (canceled)

16. The method of claim 1, further comprising supporting a catalytically active material on a surface of the dielectric coating of the solid bed particles, the catalytically active material being heated via thermal conduction from the heated dielectric coating and further increasing conversion of the surrounding gaseous reactants into the primary products.

17. The method of claim 16, wherein supporting the catalytically active material is performed via impregnation, plasma deposition, polyol-assisted deposition, hydrothermal synthesis or ultrasound-assisted deposition.

18. A bed particle comprising a core particle and a dielectric coating deposited on an external surface of the core particle, the bed particle being sized for use in a fixed bed reactor or a fluidized bed reactor.

19. (canceled)

20. The bed particle of claim 18, wherein the core particle is made of silica, alumina, olivine, FCC, zeolite quartz, glass or a combination thereof.

21. The bed particle of claim 18, wherein the dielectric coating is made of a metallic compound, a carbonaceous compound, or a combination thereof.

22-24. (canceled)

25. The bed particle of claim 18, being a carbon-coated sand particle, wherein the core particle is made of silica sand and the dielectric coating is made of carbon.

26. The bed particle of claim 25, having a carbon content between 0.1 wt % and 3 wt % with respect to a total weight of the particle.

27. The bed particle of claim 25, wherein the carbon-coated sand particles have a particle size between 200 and 250 μm.

28. The bed particle of claim 25, wherein the dielectric coating comprises a plurality of carbon nanosized layers deposited on the core.

29. (canceled)

30. The bed particle of claim 18, further comprising a catalytic material supported on the dielectric coating and having active sites.

31-33. (canceled)

34. The method of claim 1, wherein the conversion of the gaseous reactants into the primary products is partial oxidation of hydrocarbons such as n-butane, pyrolysis, biomass gasification, thermal cracking, gas cleaning and any thermochemical conversion.

35-43. (canceled)

44. The method of claim 16, wherein the gaseous reactants comprise methane which is reformed into the primary products which are syngas, via the primary gas-phase reaction: CH₄+CO₂→2CO+2H₂.
